(19) United States
(12) Patent Application Publication
(10) Pub. No.: US 2026/0320886 A1
(43) Pub. Date: Oct. 15, 2026

(54) TEMPORALLY-ALIGNED CROSS-MODAL AUDIOVISUAL DIFFUSION MODEL

(71) Applicant: Snap Inc., Santa Monica, CA (US)

(72) Inventors: Moayed Haji Ali, Houston, TX (US); Alper Canberk, New York, NY (US); Kwot Sin Lee, Weehawken, NJ (US); Willi Menapace, Los Angeles, CA (US); Aliaksandr Siarohin, Santa Monica, CA (US); Ivan Skorokhodov, Santa Monica, CA (US); Sergey Tulyakov, Santa Monica, CA (US)

(21) Appl. No.: 19/177,417

(22) Filed: Apr. 11, 2025

(51) Int. Cl. G06T 13/20; G06V 10/774; G06V 10/82; G06V 20/40; G10L 21/0208; G10L 25/57

(52) U.S. Cl. CPC G06T 13/205; G06V 10/774; G06V 10/82; G06V 20/46; G10L 21/0208; G10L 25/57

(57) ABSTRACT

Examples relate to systems and methods for cross-modal audiovisual generation using diffusion features. A multi-modal diffusion model includes a first modality path comprising diffusion transformer (DiT) blocks pretrained to generate outputs of a first modality, a second modality path comprising DiT blocks pretrained to generate outputs of a second modality, and fusion blocks connecting the paths. Each fusion block receives activations from both modality paths, establishes temporal correspondence between them using self-attention mechanisms with rotary position embeddings, and provides modified activations back to subsequent DiT blocks in both paths. The system processes an input in one modality to generate temporally-aligned output in the other modality, with the fusion blocks enabling bidirectional information exchange while maintaining temporal alignment. The approach eliminates the need for specialized feature extractors by leveraging the activations of frozen pretrained diffusion models.

### TECHNICAL FIELD

The present disclosures relate to generative artificial intelligence and, in some examples, to methods and systems to generate temporally-aligned cross-modal content between audio and video using diffusion features.

### BACKGROUND

Artificial Intelligence (AI) has made significant strides in recent years, particularly in the domains of computer vision and natural language processing. Machine learning techniques, such as deep learning and neural networks, have enabled AI systems to process and generate complex visual and textual data with increasing sophistication. In the realm of video generation, diffusion models can be used to create high-quality, diverse content from text or image inputs. These models work by gradually denoising random noise to produce coherent video frames, guided by the input prompt. Transformer architectures, originally developed for natural language tasks, have been adapted for video and audio generation, potentially offering improved quality, scalability, and/or training efficiency.

Extended Reality (XR) technologies, encompassing Virtual Reality (VR), Augmented Reality (AR), and Mixed Reality (MR), provide immersive and interactive experiences. These technologies rely on 3D rendering techniques to create convincing virtual environments or overlay virtual content onto the real world. The development of lightweight, high-resolution displays and advanced motion tracking systems has the potential to further improve user experience in XR applications.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. The drawings illustrate examples. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. Some non-limiting examples are illustrated in the figures of the accompanying drawings in which:

### BRIEF DESCRIPTION OF THE DRAWINGS

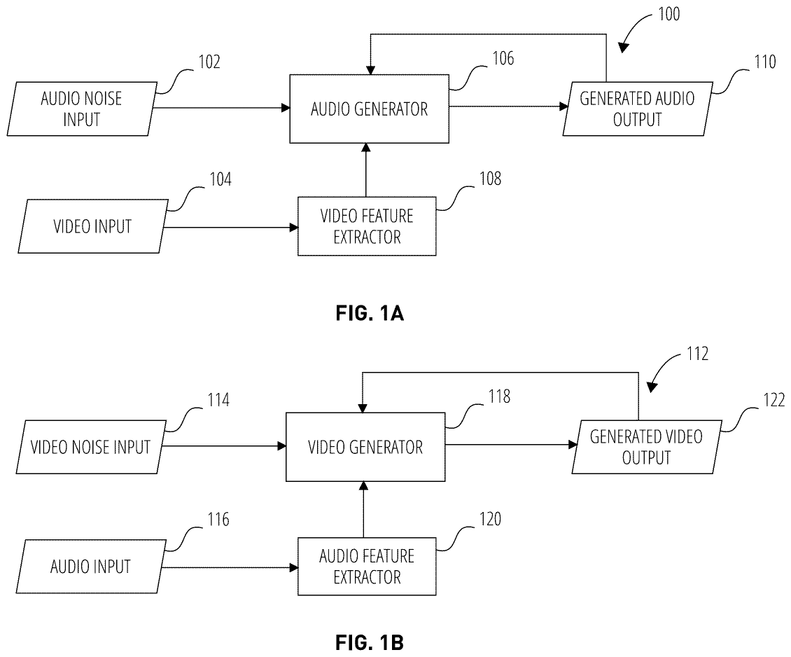

FIG. 1A is a block diagram illustrating an example video-to-audio generation model, providing context for described examples.

FIG. 1B is a block diagram illustrating an example audio-to-video generation model, providing context for described examples.

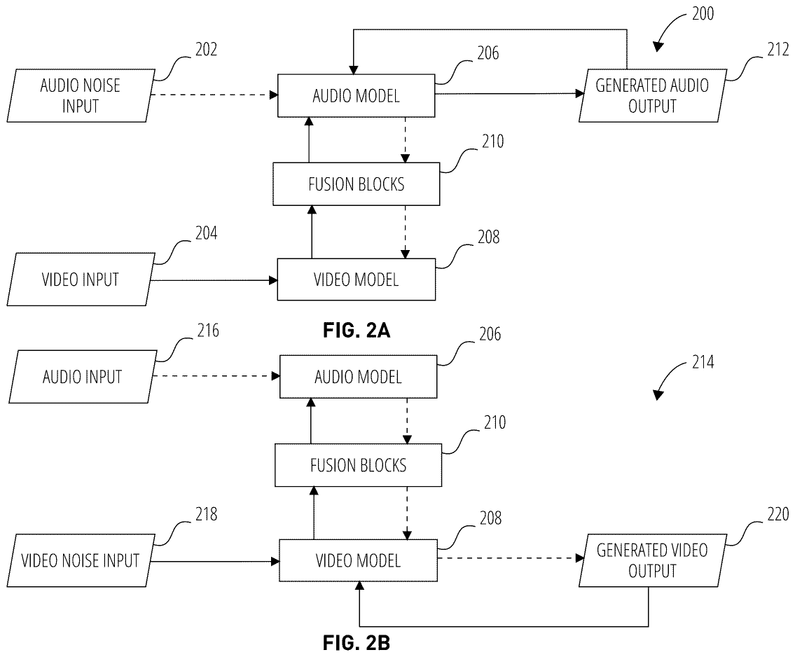

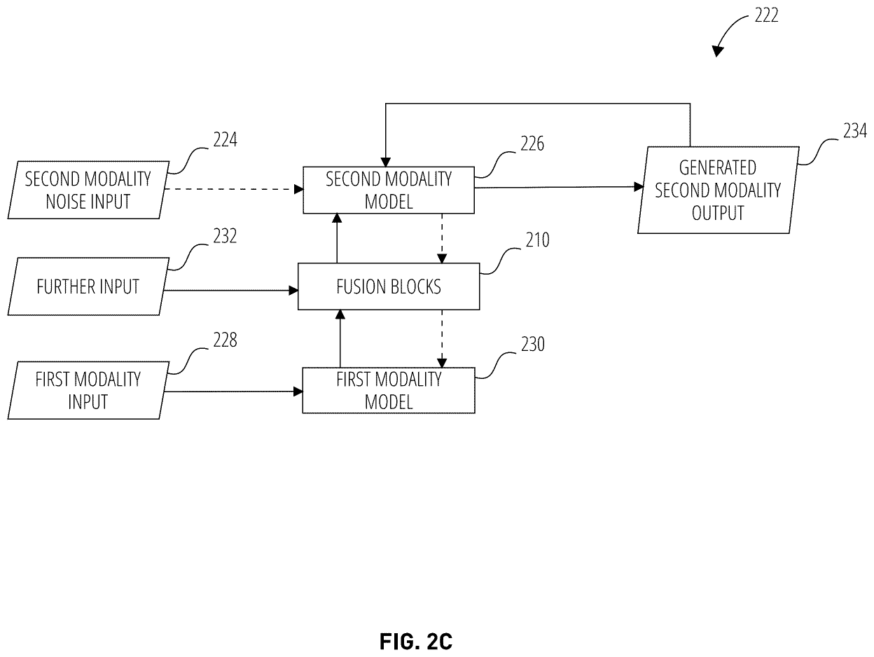

FIG. 2A is a block diagram illustrating a temporally-aligned multi-modal video-to-audio diffusion model, according to some examples.

FIG. 2B is a block diagram illustrating a temporally-aligned multi-modal audio-to-video diffusion model, according to some examples.

FIG. 2C is a block diagram illustrating a generalized temporally-aligned multi-modal diffusion model, according to some examples.

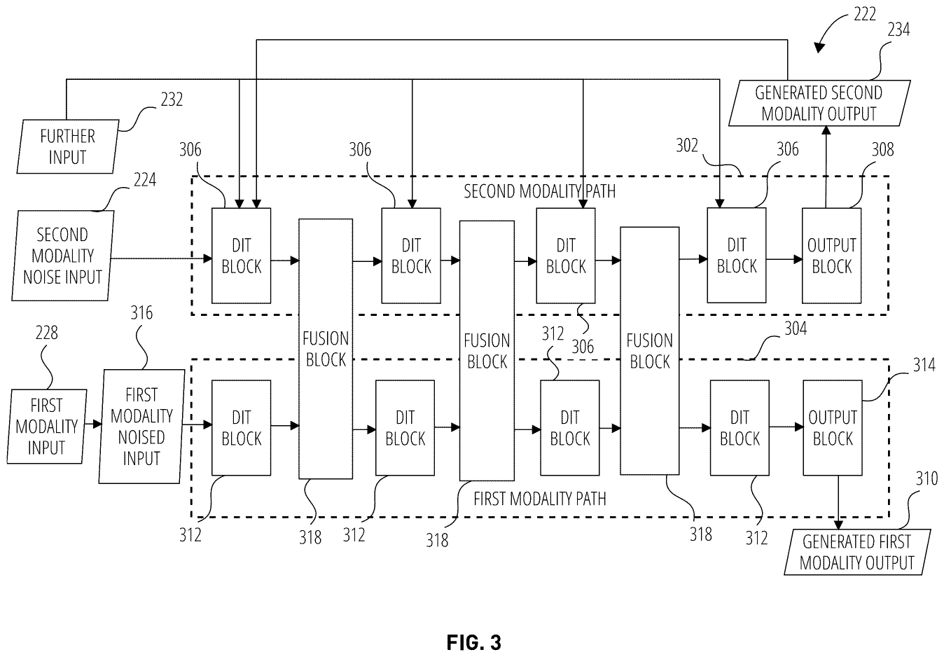

FIG. 3 is a detailed block diagram illustrating the architecture of a temporally-aligned multi-modal diffusion model with multiple fusion blocks interleaved with diffusion transformer (DiT) blocks of a first modality path and a second modality path, according to some examples.

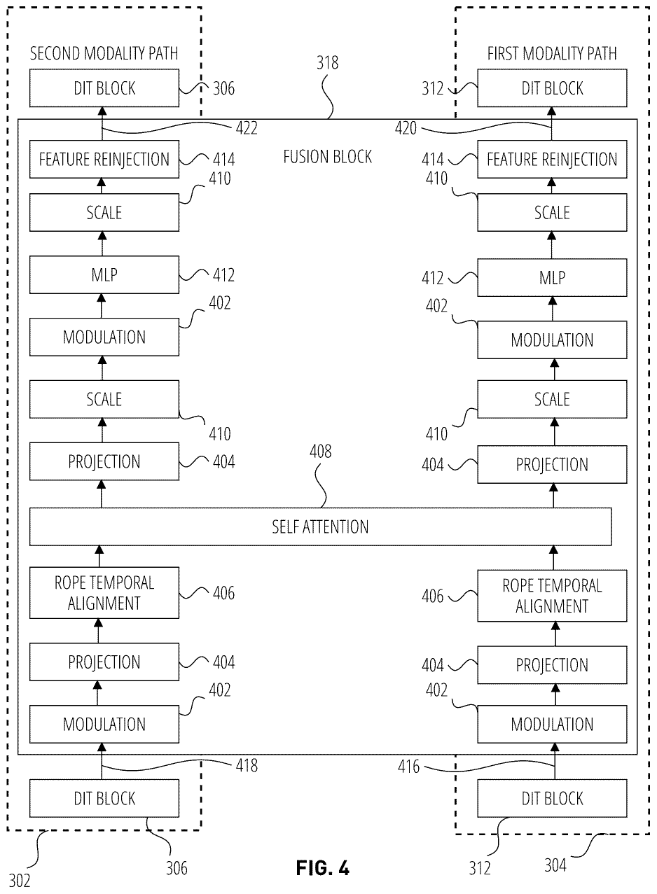

FIG. 4 is a detailed block diagram illustrating the structure of an example fusion block for providing cross-modal conditioning between the first and second modality paths, according to some examples.

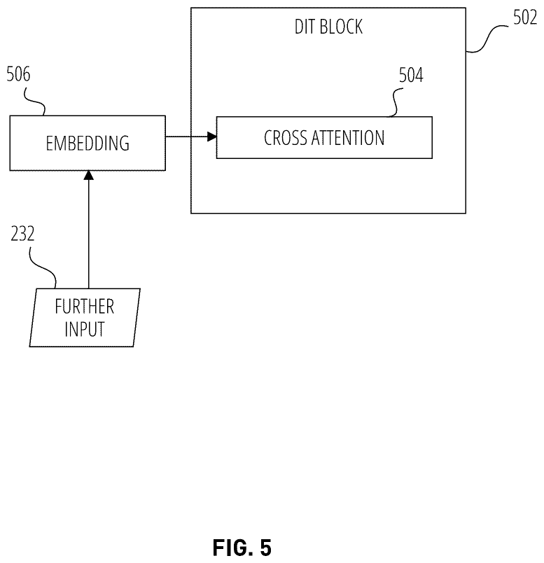

FIG. 5 is a block diagram illustrating an example DiT blockwith text conditioning, according to some examples.

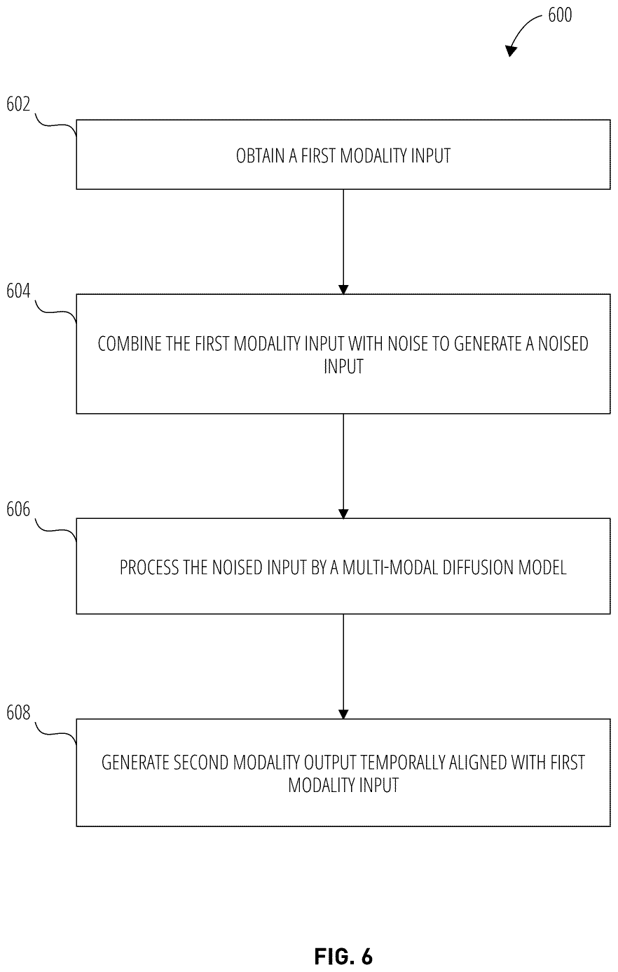

FIG. 6 is a flowchart illustrating a method for generating temporally-aligned cross-modal content, according to some examples.

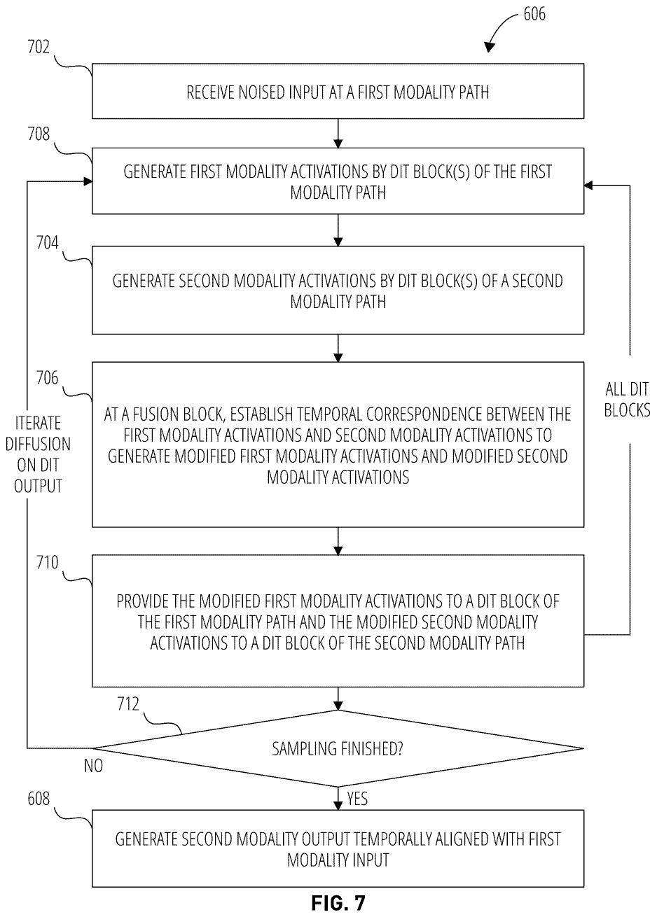

FIG. 7 is a flowchart illustrating a detailed process for generating temporally-aligned cross-modal content using fusion blocks, according to some examples.

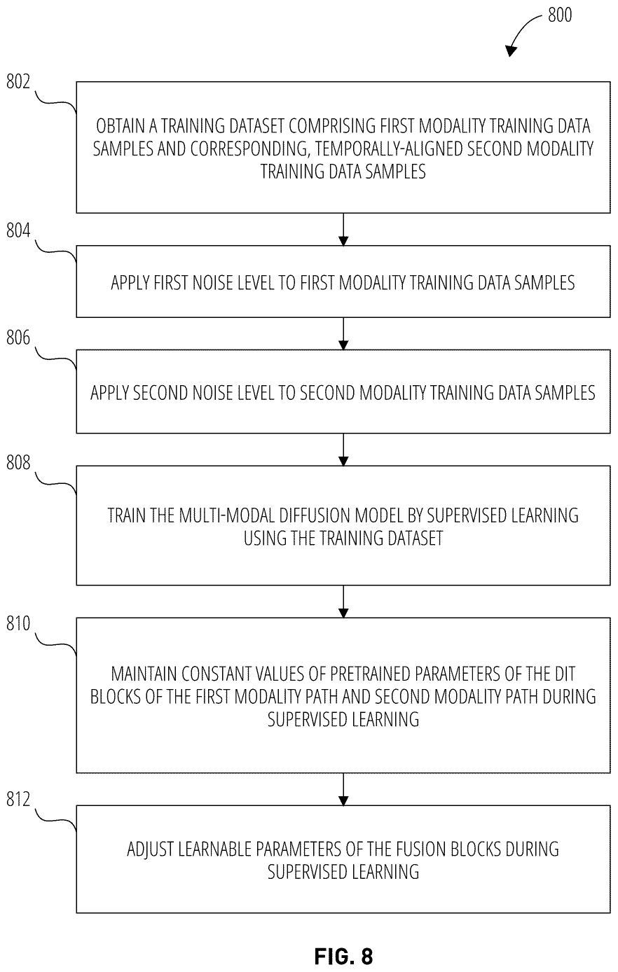

FIG. 8 is a flowchart illustrating a method for training a multi-modal diffusion model, according to some examples.

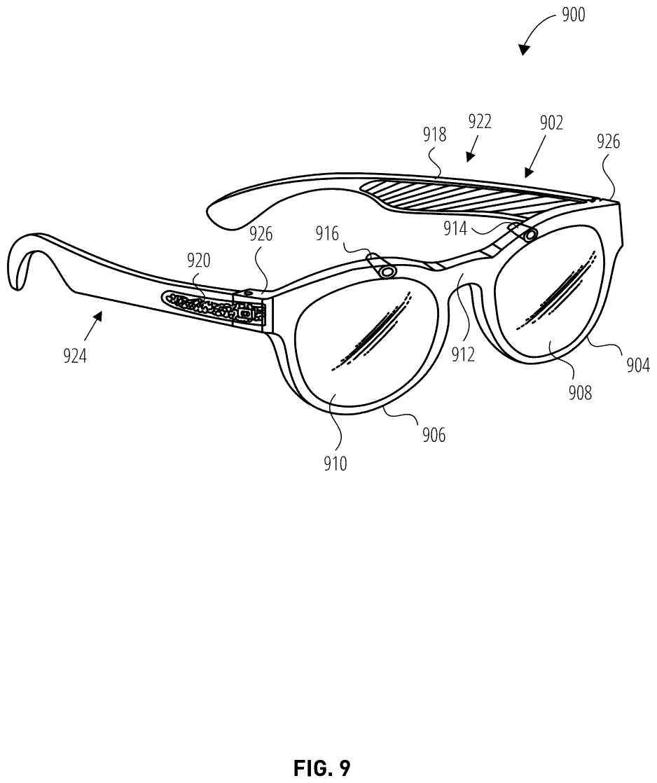

FIG. 9 is a perspective view of a head-worn device, in accordance with some examples.

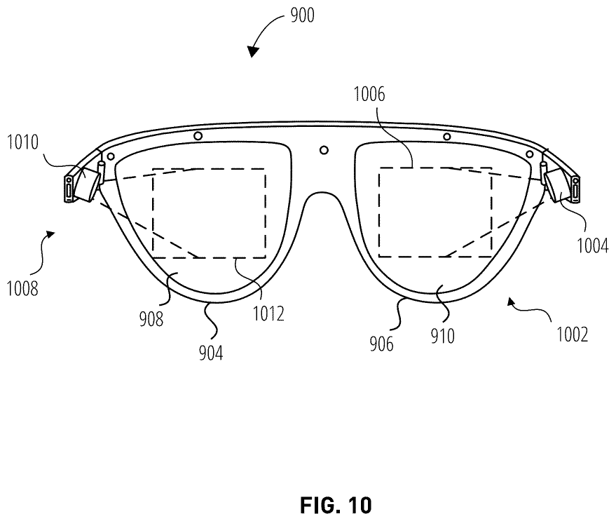

FIG. 10 illustrates a further view of the head-worn device of FIG. 9, in accordance with some examples.

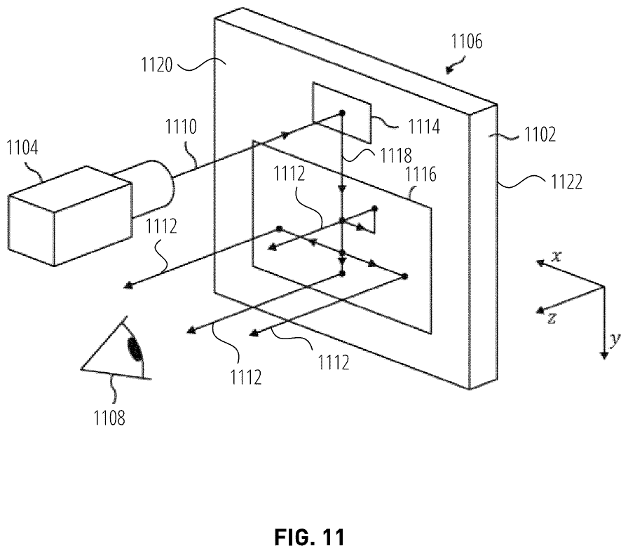

FIG. 11 illustrates a perspective view of a projector and waveguide, showing light propagated toward an eye, in accordance with some examples.

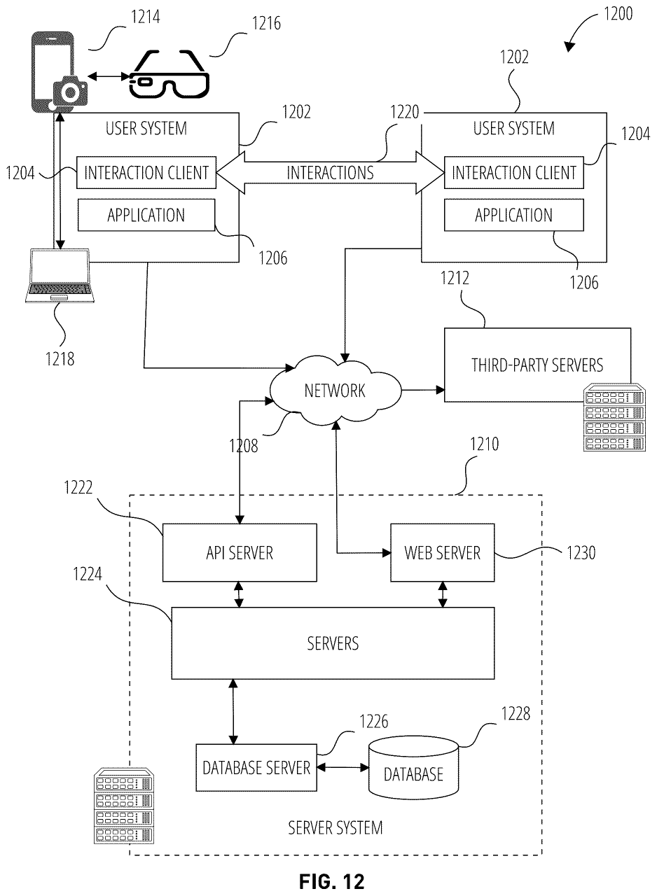

FIG. 12 is a diagrammatic representation of a networked environment in which the present disclosure may be deployed, according to some examples.

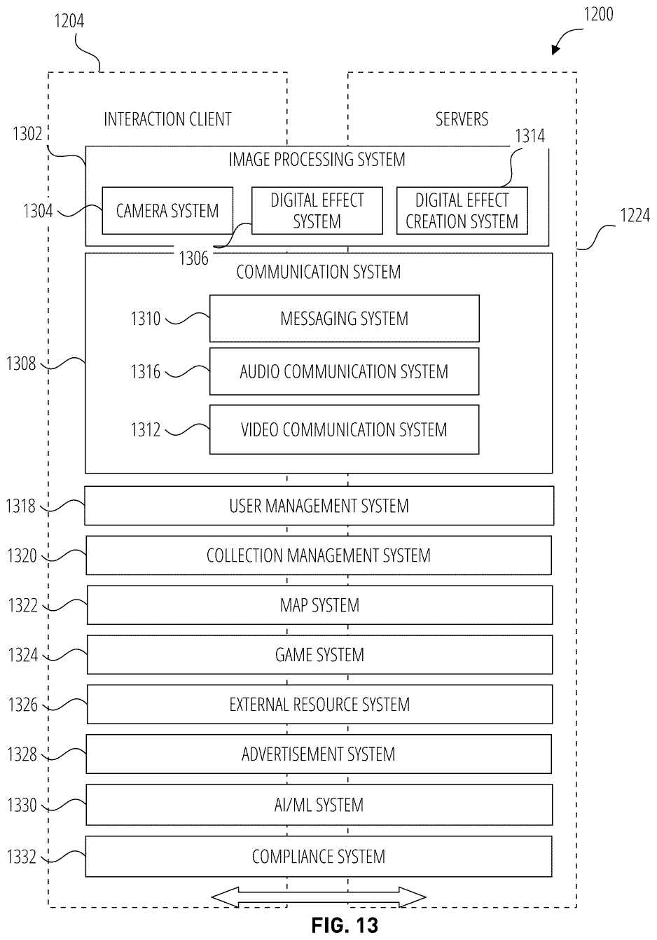

FIG. 13 is a diagrammatic representation of a digital interaction system that has both client-side and server-side functionality, according to some examples.

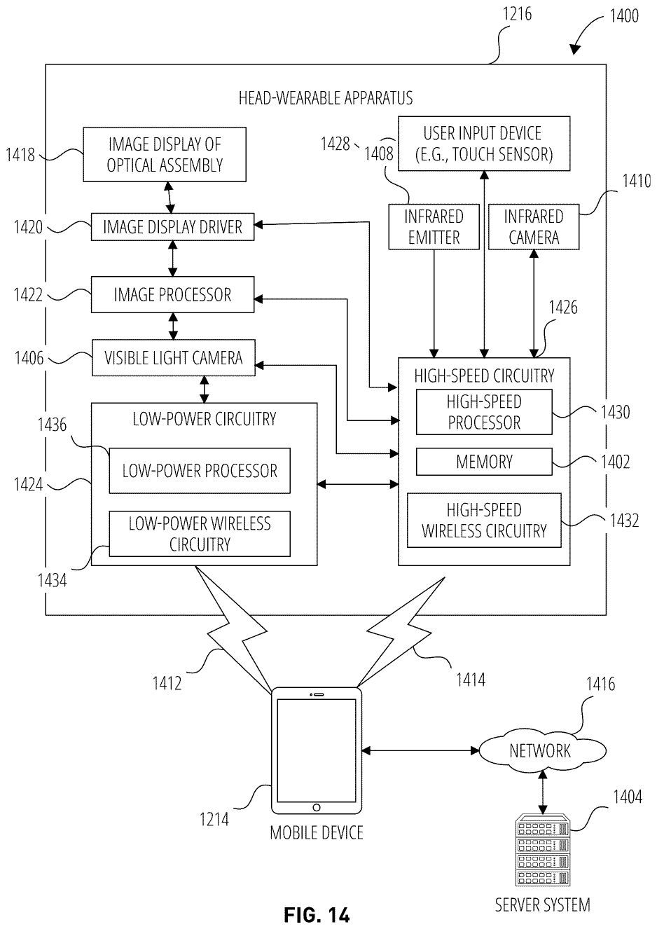

FIG. 14 illustrates a system including a head-wearable apparatus, according to some examples.

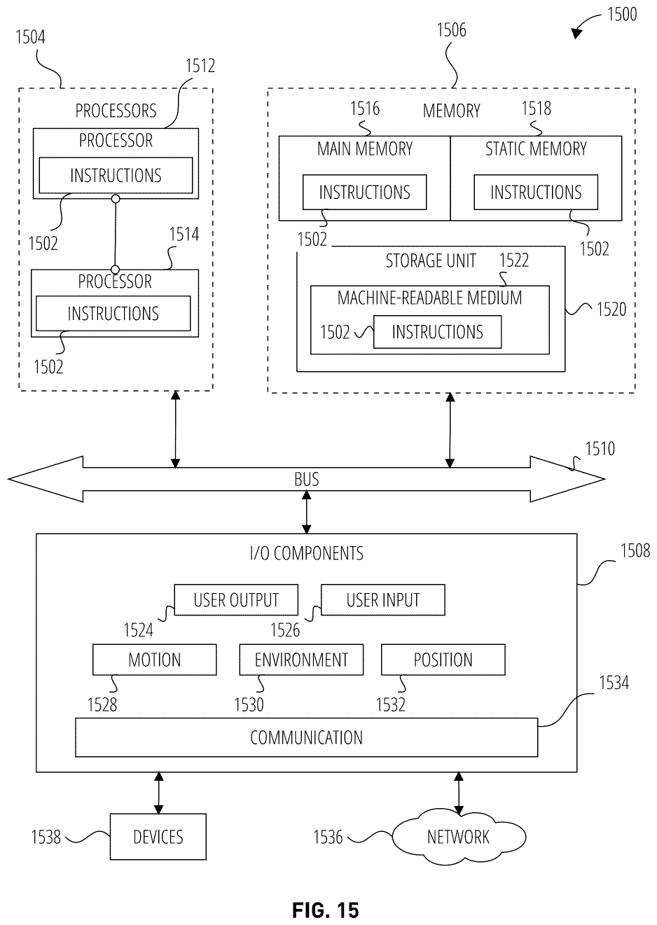

FIG. 15 is a diagrammatic representation of a machine in the form of a computer system within which a set of instructions may be executed to cause the machine to perform any one or more of the methodologies discussed herein, in accordance with some examples.

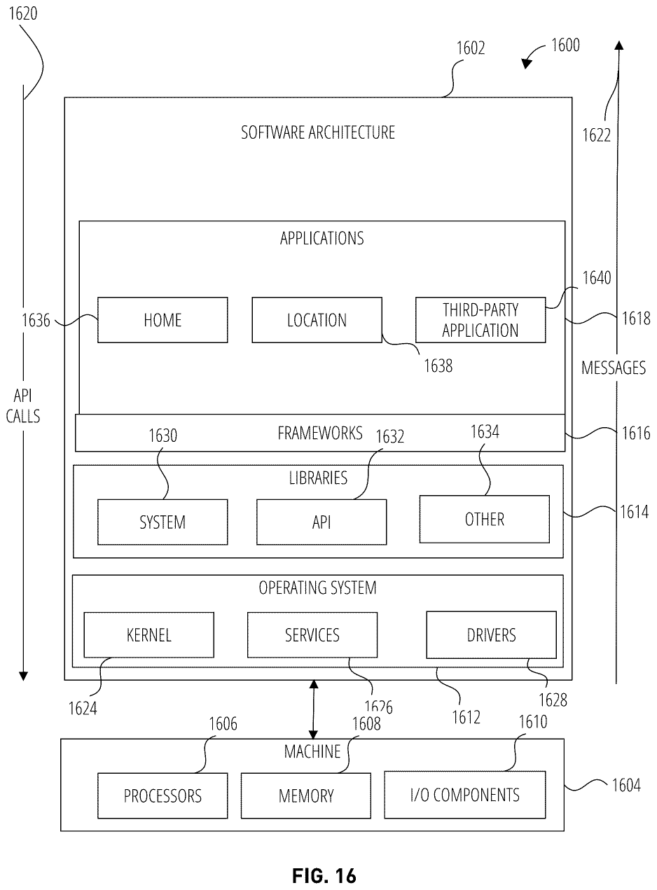

FIG. 16 is a block diagram showing a software architecture within which examples may be implemented, in accordance with some examples.

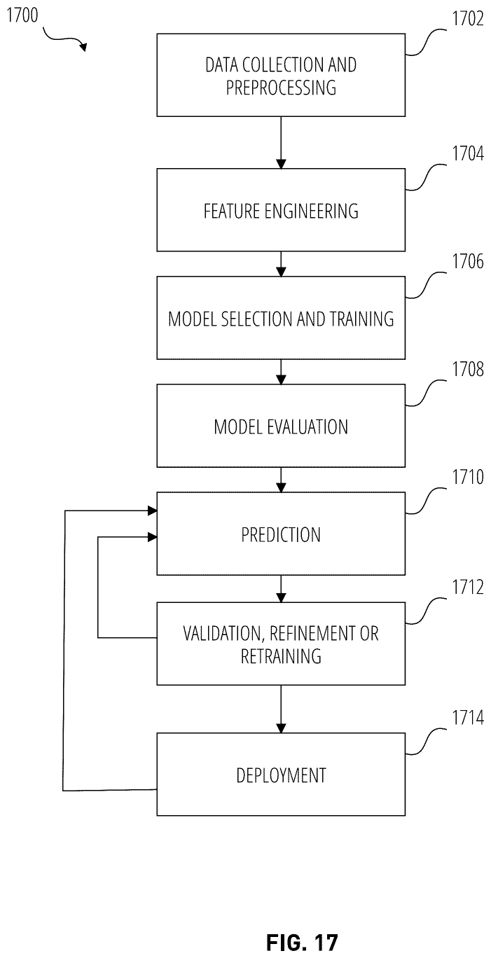

FIG. 17 illustrates a machine-learning pipeline, according to some examples.

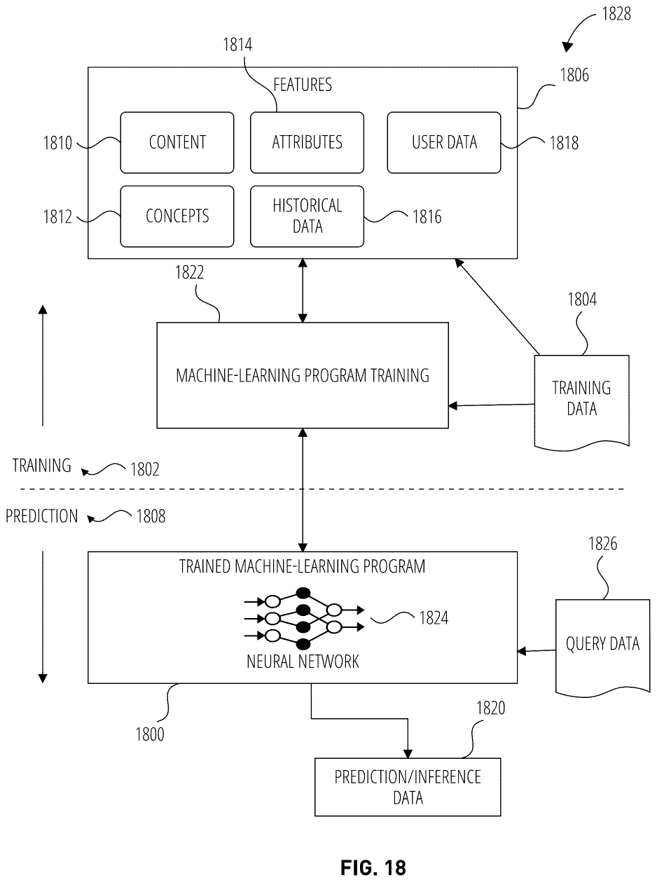

FIG. 18 illustrates training and use of a machine-learning program, according to some examples.

### DETAILED DESCRIPTION

The examples described herein relate to systems, methods, and machine-readable media for cross-modal audiovisual generation using diffusion features. Some examples described herein may address challenges in generating temporally-aligned content across different modalities, such as between audio and video modalities.

Some existing approaches to cross-modal media generation rely on specialized feature extractors pretrained for other tasks. For video-to-audio (V2A) generation, some such approaches extract video features using models such as CLIP or ImageBind, then use these features to condition audio generation. Similarly, for audio-to-video (A2V) generation, audio features can be extracted using models such as CLAP or BEATs to condition video generation. While these approaches can achieve semantic alignment, they often struggle with temporal alignment between the generated content and the conditioning input.

Some examples described herein provide a unified framework for both video-to-audio and audio-to-video generation that can potentially achieve improved temporal alignment without requiring specialized feature extractors. This framework leverages the activations of pretrained diffusion models as conditioning signals, bypassing the need for separate feature extractors while maintaining temporal coherence between modalities.

A multi-modal diffusion model is provided, including three main components: a first modality path, a second modality path, and a series of fusion blocks. The first modality path includes a series of diffusion transformer (DiT) blocks pretrained to generate outputs in the first modality (e.g., video), while the second modality path includes a series of DiT blocks pretrained to generate outputs in the second modality (e.g., audio). These paths are interconnected through fusion blocks that establish temporal correspondence between the activations of both modalities.

Each fusion block receives activations from both modality paths and processes them through a self-attention mechanism using rotary position embeddings (RoPE) to bias tokens in both modalities that correspond to the same temporal position to preferentially exchange information. This temporal alignment mechanism can help to ensure that events in the generated output align with corresponding events in the input.

In some examples, a symmetric feature reinjection mechanism is provided. After the fusion block processes the activations from both modalities, the modified activations are provided back to subsequent DiT blocks in both paths. This approach can allow for continuous refinement of the conditioning features according to the generated modality, improving the quality of cross-modal alignment.

The multi-modal diffusion model processes inputs by first combining the input in a first modality (e.g., video) with noise to generate a noised input. The noise level is selected to preserve details relevant for cross-modal alignment. The multi-modal diffusion model then processes this noised input through a first modality path to condition the inference performed by a second modality path. The output is generated in the second modality (e.g., audio) and is at least partially temporally aligned with the input in the first modality.

For video-to-audio generation, the multi-modal diffusion model can be trained specifically to operate as a video-to-audio diffusion model. The video-to-audio diffusion model takes a video input, applies a small amount of noise to preserve visual details, and generates audio that is temporally aligned with the video events. For audio-to-video generation, the multi-modal diffusion model can be trained specifically to operate as an audio-to-video diffusion model. The audio-to-video diffusion model takes an audio input, applies noise, and generates video content that visually represents the audio events with temporal synchronization.

In some examples, the multi-modal diffusion model can also incorporate text conditioning through cross-attention mechanisms. Text inputs are encoded using a T5 encoder, and the resulting embeddings are incorporated through cross-attention layers inserted after each self-attention operation in the DiT blocks. Similar techniques can be used to condition on additional inputs in non-text modalities. However, because the DiT blocks are taken from models pretrained to generate video or audio from text prompts, the use of text to condition A2V or V2A generation by the multi-modal diffusion model may be relatively straightforward to implement without requiring further models or further training processes.

In some examples, training the multi-modal diffusion model involves obtaining a dataset of temporally-aligned pairs of first and second modality samples, such as video and audio tracks of a video with sound. Different amounts of noise, such as pseudo-random or Gaussian noise, are applied to the first and second modality training samples, with a constant small noise level applied to the conditioning modality and a variable, but on average larger, noise level applied to the modality being generated. In some examples, the variable noise level applied to the samples of the modality being generated can be randomly drawn from a distribution over a range of noise levels, in which the mean of the distribution is a larger noise level than the constant small noise level applied to the samples of the conditioning modality. The model is trained using supervised learning while keeping the pretrained parameters of the DiT blocks frozen and only adjusting the learnable parameters of the fusion blocks.

Some described examples can enable applications such as adding synchronized soundtracks to silent videos, generating visual representations of audio recordings, and enhancing immersive media experiences. The approaches described herein may achieve superior temporal alignment compared to previous methods, ensuring that audio events like explosions or drumming sounds are precisely synchronized with corresponding visual events.

FIG. 1A is a block diagram illustrating an example video-to-audio generation model, shown as V2A model 100. The V2A model 100 provides context for described examples of temporally-aligned cross-modal audiovisual diffusion models, illustrating an example of a potential approach to V2A generation using existing approaches.

The V2A model 100 includes a video feature extractor 108 that receives a video input 104 and extracts video features. The video feature extractor 108 may be implemented using various pre-trained models such as CLIP, ImageBind, or other similar feature extraction architectures. The video feature extractor 108 processes the video input 104 to generate feature representations that capture semantic content of the video. The feature representations can be, for example, activations of blocks or layers of a neural network of the video feature extractor 108 which are fed forward to one or more blocks or layers of a neural network of an audio generator 106.

The extracted video features from the video feature extractor 108 are provided to an audio generator 106. The audio generator 106 receives the video features from the video feature extractor 108 and an audio noise input 102 and generates a corresponding generated audio output 110 based on these features. The audio noise input 102 can be random noise in an audio format, which the audio generator 106 iteratively de-noises to generate a de-noised output as generated audio output 110. The audio generator 106 may be implemented as a diffusion model or other generative architecture capable of producing audio content.

In this configuration, the V2A model 100 establishes a unidirectional flow of information from the video modality to the audio modality. The video feature extractor 108 processes the video input 104 to extract semantic representations, which are then used by the audio generator 106 to condition the generation of audio content and output the generated audio output 110. This approach may achieve semantic alignment between the generated audio and the input video, but may struggle with temporal alignment between the two modalities.

The V2A model 100 represents a possible existing approach to cross-modal generation where specialized feature extractors pre-trained for other tasks are used to extract conditioning signals from the input modality (in this case, video). While this approach can capture semantic content, it often lacks precise temporal alignment capabilities, which is important for realistic cross-modal audio-video generation.

FIG. 1B is a block diagram illustrating an example audio-to-video generation model, shown as A2V model 112. Like the V2A model 100 in FIG. 1A, the A2V model 112 provides context for described examples of temporally-aligned cross-modal audiovisual diffusion models, illustrating an example of a potential approach to A2V generation using existing approaches.

The A2V model 112 includes an audio feature extractor 120 that receives an audio input 116 and extracts audio features. The audio feature extractor 120 may be implemented using various pre-trained models such as CLAP, BEATs, or other similar audio feature extraction architectures. The audio feature extractor 120 processes the audio input 116 to generate feature representations that capture semantic content of the audio. The feature representations can be, for example, activations of blocks or layers of a neural network of the audio feature extractor 120 which are fed forward to one or more blocks or layers of a neural network of a video generator 118.

The extracted audio features from the audio feature extractor 120 are provided to a video generator 118. The video generator 118 receives the audio features from the audio feature extractor 120 and a video noise input 114 and generates a corresponding generated video output 122 based on these features. The video noise input 114 can be random noise in a video format, which the video generator 118 iteratively de-noises to generate a de-noised output as generated video output 122. The video generator 118 may be implemented as a diffusion model or other generative architecture capable of producing video content.

Similar to the V2A model 100 in FIG. 1A, the A2V model 112 establishes a unidirectional flow of information, but in the opposite direction: from the audio modality to the video modality. The audio feature extractor 120 processes the audio input 116 to extract semantic representations, which are then used by the video generator 118 to condition the generation of video content. This approach may achieve semantic alignment between the generated video and the input audio, but may struggle with temporal alignment between the two modalities.

The A2V model 112 represents another possible existing approach to cross-modal generation where specialized feature extractors pre-trained for other tasks are used to extract conditioning signals from the input modality. Like the V2A model 100 of FIG. 1A, the A2V model 112 may lack precise temporal alignment capabilities, which is important for realistic cross-modal audio-video generation.

FIG. 2A is a block diagram illustrating a temporally-aligned V2A diffusion model 200, according to some examples of the present disclosure. The temporally-aligned V2A diffusion model 200 uses fusion blocks 210 to improve temporal alignment between video content processed by a video model 208 and audio content processed by an audio model 206, thereby improving the temporal alignment of the generated audio output 212 to the original video input 204.

The audio model 206 provides a data processing path for audio data. In some examples, the audio model 206 receives an audio noise input 202 as a starting point for audio generation. The audio noise input 202 can be pure noise, such as Gaussian noise, or another blank, random, or pseudo-random audio data input. In some examples, the audio noise input 202 may be generated by applying Gaussian noise or pseudo-random noise to an audio sample. The noise level applied to generate the audio input can be selected to facilitate the diffusion process. In some examples, the audio model 206 does not rely on an audio noise input 202; instead, an input block or initial processing block of the audio model 206 generates a set of activations within the audio model 206 based on predetermined or internally generated data.

The video model 208 provides a data processing path for video data. The video model 208 receives a video input 204, which is used by the temporally-aligned V2A diffusion model 200 to condition the generated audio output 212, thereby generating generated audio output 212 that corresponds to and temporally aligns with the video input 204. In some examples, the video input 204 can be slightly noised before being provided to the video model 208 in order to improve performance: because the video model 208 uses blocks of a video diffusion model that was originally trained with noisy videos, the performance of the video model 208 may be improved when processing video inputs that include at least some non-zero level of noise.

The audio model 206 includes a series of diffusion transformer (DiT) blocks of an audio diffusion model pretrained to generate audio outputs. The audio model 206 processes the audio noise input 202 and progressively removes noise through multiple iterations of a diffusion process. In some examples, the audio model 206 can be an audio diffusion model trained to generate audio outputs based on text inputs and/or other inputs. In some examples, the audio model 206 can be implemented as a 1D-VAE model with a DiT backbone consisting of approximately 600 million parameters.

Similarly, the video model 208 includes a series of DiT blocks of a video diffusion model pretrained to generate video outputs. The video model 208 processes the video input 204 and generates activations that are used to condition the audio generation of the audio model 206. In some examples, the video model 208 can be a video diffusion model trained to generate video outputs based on text inputs and/or other inputs. In some examples, the video model 208 can contain approximately 600 million parameters.

The fusion blocks 210 connect the audio model 206 and the video model 208, enabling bidirectional information exchange between the two modalities. The fusion blocks 210 are interleaved at regular intervals throughout the series of DiT blocks of both models. The fusion blocks 210 receive activations from both the audio model 206 and the video model 208, establish temporal correspondence between these activations, and provide modified activations back to both models. This bidirectional exchange may be referred to herein as symmetric feature reinjection.

Within each fusion block, a self-attention mechanism uses rotary position embeddings (RoPE) to bias tokens from both modalities that correspond to the same temporal position to preferentially exchange information. This temporal alignment mechanism helps ensure that events in the generated audio align with corresponding events in the input video.

The generated audio output 212 is produced by the audio model 206 after multiple iterations of the diffusion process. The generated audio output 212 is temporally aligned with the video input 204, meaning that audio events in the generated audio output 212 are synchronized with corresponding visual events in the video input 204. For example, the sound of an explosion in the generated audio output 212 may be precisely timed to match the visual explosion in the video input 204.

The temporally-aligned V2A diffusion model 200 may be trained using a dataset of temporally-aligned pairs of video and audio samples. During training, the pretrained parameters of the DiT blocks in both the audio model 206 and video model 208 remain frozen, while only the learnable parameters of the fusion blocks 210 are adjusted through supervised learning.

FIG. 2B illustrates a temporally-aligned A2V diffusion model 214, which represents the inverse operation of the temporally-aligned V2A diffusion model 200 shown in FIG. 2A. While the temporally-aligned V2A diffusion model 200 generates audio from video input, the temporally-aligned A2V diffusion model 214 generates video from audio input. As described in greater detail below with reference to FIG. 8, the same model architecture can be trained to operate as either a temporally-aligned V2A diffusion model 200 or a temporally-aligned A2V diffusion model 214.

An audio input 216 serves as the conditioning input for the temporally-aligned A2V diffusion model 214, similar to how the video input 204 serves as the conditioning input to the temporally-aligned V2A diffusion model 200 in FIG. 2A. The audio input 216 is processed by the audio model 206, which generates activations that are temporally aligned with the audio content.

A video noise input 218 provides a starting point for the video generation process. Like the audio noise input 202 of FIG. 2A, the video noise input 218 may be pure noise, such as Gaussian noise, or another blank, random, or pseudo-random video data input. In some examples, the video noise input 218 may be generated by applying Gaussian noise or pseudo-random noise to a video sample.

The fusion blocks 210 function similarly to those of the temporally-aligned V2A diffusion model 200, establishing bidirectional information exchange between the audio model 206 and video model 208. The fusion blocks 210 enable temporal alignment between the audio and video modalities through the same mechanisms described above with reference to FIG. 2A.

The generated video output 220 is the final product of the temporally-aligned A2V diffusion model 214, representing video content that is temporally aligned with the audio input 216. This means that visual events in the generated video output 220 are synchronized with corresponding audio events in the audio input 216.

The symmetrical nature of the architecture between the temporally-aligned V2A diffusion model 200 and temporally-aligned A2V diffusion model 214 demonstrates a unified framework approach, in which the same architectural principles can be applied for both video-to-audio and audio-to-video generation tasks.

FIG. 2C illustrates a temporally-aligned multi-modal diffusion model 222, which provides a generalized framework that extends the concepts shown in FIG. 2A and FIG. 2B. The temporally-aligned multi-modal diffusion model 222 represents an abstraction that can be applied to various modality pairs beyond just audio and video, and which in some examples can further condition the output on additional inputs, potentially in additional modalities.

In some examples, the temporally-aligned multi-modal diffusion model 222 could be applied to modalities other than audio and video, such as text or motion data, where gestures and body movements are precisely synchronized with spoken or written text to enable natural human-like animations for virtual avatars or digital humans. Additionally, this framework could temporally align tactile feedback with visual stimuli in extended reality applications, ensuring that haptic sensations are delivered at precisely the right moment when a user visually interacts with virtual objects. Text subtitles could be aligned with audio and/or video tracks of a sound video. It will be appreciated that other modalities can be processed, generated, and/or temporally aligned using techniques described herein.

The temporally-aligned multi-modal diffusion model 222 includes a first modality model 230 (such as a video model), a second modality model 226 (such as an audio model), and fusion blocks 210.

In this generalized architecture, the first modality input 228 serves as the conditioning input for the model. The first modality input 228 is processed by the first modality model 230, which extracts features and activations that represent the content of the first modality. The first modality model 230 may be implemented using a series of diffusion transformer (DiT) blocks pretrained to generate outputs in the first modality. As in the temporally-aligned V2A diffusion model 200 of FIG. 2A and the temporally-aligned A2V diffusion model 214 of FIG. 2B, the first modality input 228 can be noised before being processed by the first modality model 230.

The second modality noise input 224 provides a starting point for the generation process in the second modality. This input may be pure noise, such as Gaussian noise, or another blank, random, or pseudo-random data input in the second modality format. The second modality model 226 processes this second modality noise input 224 and progressively removes noise through multiple iterations of a diffusion process to generate the generated second modality output 234. The second modality model 226 may be implemented using a series of DiT blocks pretrained to generate outputs in the second modality.

The fusion blocks 210 connect the first modality model 230 and the second modality model 226, enabling bidirectional information exchange between the two modalities. These fusion blocks 210 establish temporal correspondence between activations from both modality paths, ensuring that the generated second modality output 234 is temporally aligned with the first modality input 228.

In some examples, a further input 232 provides additional conditioning information that may be used to influence the generation process. In some examples, this further input 232 may be text that describes the desired content or characteristics of the generated output. An example of a temporally-aligned multi-modal diffusion model 222 using a further input 232 to condition the output is described in greater detail below with reference to FIG. 5.

The generated second modality output 234 is the final product of the temporally-aligned multi-modal diffusion model 222, representing content in the second modality that is temporally aligned with the first modality input 228.

This generalized architecture demonstrates how the same principles of temporally-aligned cross-modal generation can be applied to various modality pairs, providing a unified framework for cross-modal content generation with temporal alignment.

FIG. 3 illustrates a detailed block diagram of the temporally-aligned multi-modal diffusion model 222, showing the architecture with multiple fusion blocks 318 interleaved with diffusion transformer (DiT) blocks of a first modality path 304 and a second modality path 302.

The first modality path 304 corresponds to the first modality model 230 of FIG. 2C. In some examples, a first modality input 228 (such as a source video being used as the basis for generating a corresponding audio track) has noise applied to it to generate a first modality noised input 316. As described above, a small amount of noise is applied to the conditioning input (in this case, the first modality input 228) to improve performance because the original diffusion models were trained with noisy inputs, making them perform better when processing inputs that include at least some non-zero level of noise. The noise level can be specifically selected to preserve details in the input that are relevant for cross-modal alignment, ensuring that high-frequency details that may determine significant variations in the output modality are not erased. As described herein, the noise level of a given sample can be measured on a scale from 0.0 to 1.0, in which 0.0 is pure noise and 1.0 is a clean sample with zero noise. This measure can also be referred to as “flow time” in some cases, in reference to the progressive de-noising over multiple time steps or iterations of the diffusion process.

The first modality noised input 316 (or, in some examples, the raw first modality input 228) is provided as an input to the first modality path 304. The first modality path 304 includes a series of DiT blocks 312 that process the first modality data. These DiT blocks 312 are DiT blocks of a DiT model pretrained to generate outputs in the first modality. The order of the DiT blocks from the original pretrained model is preserved in the arrangement of the DiT blocks 312 in the first modality path 304. Because DiT models use a relatively straightforward architecture, in which uniform DiT blocks are arranged in series to perform successive denoising operations of an input, the DiT architecture is well suited to the repurposing of its pretrained DiT blocks as used in the temporally-aligned multi-modal diffusion model 222.

Similarly, the second modality path 302 includes a series of DiT blocks 306 that process data from the second modality noise input 224. These DiT blocks 306 are taken from a DiT model pretrained to generate outputs in the second modality.

The fusion blocks 318 are interleaved at regular intervals throughout the DiT blocks of both modality paths. In some examples, eight fusion blocks 318 may be distributed uniformly across the architecture. Thus, for example, in an example temporally-aligned multi-modal diffusion model 222 with 24 DiT blocks (312 or 306) in each modality path, eight fusion blocks 318 may be interleaved at regular intervals, with one fusion block 318 inserted after every three DiT blocks to maintain uniform distribution throughout the architecture. For larger models with 30 DiT blocks per modality path, eight fusion blocks 318 could be inserted after every 3 or 4 DiT blocks, as uniformly as possible. In ablation studies performed on examples described herein, uniform distribution of the fusion blocks 318 among the DiT blocks has been shown to provide superior performance compared to alternative arrangements such as placing all fusion blocks at the beginning, middle, or end of the model.

Each fusion block 318 connects the first modality path 304 and the second modality path 302, enabling bidirectional information exchange between the two modalities. The fusion blocks 318 receive activations from both modality paths, establish temporal correspondence between these activations, and provide modified activations back to both paths. This bidirectional exchange is referred to as symmetric feature reinjection, in which the enriched or modified outputs from each fusion block 318 are propagated in both pipelines.

The first modality path 304 terminates with an output block 314 that may generate a generated first modality output 310. The generated first modality output 310 corresponds to a denoised, or partially denoised, version of the first modality noised input 316 (or the first modality input 228). It is therefore not used; instead, it can either be discarded or not generated (in which case, the output block 314 can be omitted from the model). Instead, each subsequent iteration of the de-noising process performed by the first modality path 304 can use the same, initial first modality noised input 316.

The second modality path 302 terminates with an output block 308 that generates a generated second modality output 234. The generated second modality output 234 is temporally aligned with the first modality input 228. The generated second modality output 234 therefore corresponds to the output of the temporally-aligned multi-modal diffusion model 222 as a whole and can be provided to a user or another component of a computing system, for example, to be combined with the first modality input 228 to provide unified, temporally-aligned multi-modal media or data, such as a video with a generated soundtrack, a video with an original source soundtrack and generated visuals, an audio and/or video stream with a temporally aligned (and potentially translated) subtitles or textual descriptions, a generated video combined with source motion tracking data, and so on. However, within the inference operation of the temporally-aligned multi-modal diffusion model 222, the generated second modality output 234 is generated multiple times and fed back to the second modality path 302 (e.g., to the first DiT block 306) for repeated iteration of the de-noising diffusion process.

In some examples, the generated second modality output 234 is not generated by the output block 308 until the final iteration of the diffusion process is complete. The output fed back to the first DiT block of the second modality path 302 may not include processing performed by the output block 308. For example, after the final iteration of the diffusion process is complete, the generated second modality output 234 can be processed by a pre-trained Vocoder (e.g., included in the output block 308) that converts generated Mel-spectrograms into waveforms for audio output. For video output, the final denoised frames may be upscaled or further processed to achieve the desired resolution and frame rate for display to the user. It will be appreciated that various forms of post-processing of the model output may be included in the output block 308, and the model outputs fed back to the second modality path 302 and/or first modality path 304 may not include these post-processing modifications in some examples.

The system may also receive a further input 232 that provides additional conditioning information to influence the generation process. This further input 232 may be processed and incorporated into the model's generation process through the DiT blocks 306 of the second modality path 302. For example, the further input 232 can be a text prompt or other text data used to condition the generated content in the second modality. As an example, a source audio recording of a conversation between two people can be provided, and the further input 232 can be a textual description of the appearance or activity of the two people and/or their environment, thereby conditioning the generation of the video showing the two people conversing to reflect the text prompt. Because the pretrained DiT models can be pretrained to generate content (in the first modality or second modality, respectively) based on text inputs, some implementations of the temporally-aligned multi-modal diffusion model 222 using text as the further input 232 may be relatively straightforward. However, it will be appreciated that the further input 232 could be in any modality, including the first modality or the second modality: for example, a video or image could be used as the further input 232 to condition the generation of a further video temporally and semantically aligned with an audio source input, or an audio recording of a speaker could be used as a further input 232 to condition the generation of a soundtrack of the speaker talking.

The interleaved arrangement of fusion blocks 318 with DiT blocks (306, 312) allows for iterative refinement of the conditioning features according to the generated modality, potentially improving the quality of cross-modal alignment throughout the diffusion process.

FIG. 4 is a detailed block diagram illustrating the structure of a fusion block 318 for providing cross-modal conditioning between the first modality path 304 and second modality path 302. The fusion block 318 connects the first modality path 304 and the second modality path 302, enabling bidirectional information exchange between the two modalities.

The fusion block 318 receives inputs from DiT blocks 306 of the second modality path 302, shown as second modality activations 418, and inputs from the DiT blocks 312 of the first modality path 304, shown as first modality activations 416. These inputs consist of activations from both modality paths, which are processed through a series of operations to establish temporal correspondence between them. Examples are described below in the context of audio and video modalities.

The modulation blocks 402 at the bottom of the fusion block 318 receive the activations (416 and 418) from the DiT blocks of both modality paths. The modulation operation provides information about the noise level applied to each modality. The modulation blocks 412 receive timestep information (tₐ for audio and tᵥ for video) that indicates the current noise level for each modality, and in some examples corresponds to an iteration timestep or count of the repeated diffusion process. In the examples described herein, the audio and video activations (e.g., first modality activations 416 and second modality activations 418) can be denoted as xₐ∈R^{Ta×Da} for audio, and xᵥ∈R^{Tv×Dv} for video, at diffusion timestep tₐ, tᵥ, respectively.

Mathematically, the modulation operation can be expressed as:

x_{modulated}=Γ(t) *(x−μ(x))/σ(x)+β(t)

where γ(t) and β(t) are learnable scale and shift parameters that depend on the timestep t, and μ(x) and σ(x) are the mean and standard deviation of the input activations x, such as the first modality activations 416 or second modality activations 418.

Following the modulation blocks 402, the projection blocks 404 transform the modulated activations into a common dimension D. For example, if the original dimensions of audio and video activations (e.g., first modality activations 416 and second modality activations 418) are Dₐ and Dᵥ respectively, the projection operation maps them to a shared dimension D to produce:

x̅ₐ∈^{Ta×D}, x̅ᵥ∈^{Tv×D},

respectively.

The RoPE temporal alignment blocks 406 apply rotary position embeddings to the projected activations. This operation seeks to establish temporal correspondence between the two modalities. The RoPE temporal alignment biases tokens from both modalities that correspond to the same temporal position to preferentially exchange information.

For an example two-channel case, the RoPE temporal alignment can be expressed as:

RoPE(xₙ, τ(n))=xₙ*e^{iΣ(n)θ}_{base}

where xn represents a token at position n, θbase is the base frequency, and τ(n) is a temporal alignment function defined as:

τ(n) 32 n*(nᵥ/nₐ) if x is an audio token

τ(n)=N If X Is a Video Token

where nₐ and nᵥ are the number of tokens representing one second of audio and video respectively.

The self attention block 408 provides a self-attention mechanism that processes the concatenation of the temporally aligned audio and video tokens {x̅ₐ, x̅ᵥ}. This operation allows tokens from one modality to attend to tokens from the other modality, facilitating cross-modal information exchange. The self-attention operation can be mathematically described as:

Attention(Q, K, V)=Softmax(QK^{T}t/√d)V

where Q, K, and V are the query, key, and value matrices derived from the input tokens, and d is the dimension of the key vectors.

The self attention block 408 uses the RoPE temporal alignment to bias the attention weights, ensuring that tokens corresponding to the same temporal position in different modalities are more likely to attend to each other.

After the self attention block 408, the fusion block 318 processes the attended tokens through another series of operations. Further projection blocks 404 transform the attended tokens back to their original dimensions in each modality. Scale blocks 410 adjust the scale of the transformed tokens. Further modulation blocks 402 apply another modulation operation based on the timestep information.

MLP blocks 412 then process the modulated tokens through a series of linear transformations with non-linear activations using a multi-layer perceptron (MLP) architecture.

Further scale blocks 410 apply a final scaling operation to the MLP outputs.

The feature reinjection blocks 414 at the top of the fusion block 318 implement a symmetric feature reinjection mechanism. This mechanism provides the modified activations (modified first modality activations 420 and modified second modality activations 422) back to subsequent DiT blocks in both modality paths, allowing for continuous refinement of the conditioning features. The modified first modality activations 420 are provided to a subsequent DiT block 312 of the first modality path 304, and the modified second modality activations 422 are provided to a subsequent DiT block 306 of the second modality path 302.

The symmetric feature reinjection blocks 414 of the fusion block 318 allow both modality paths to benefit from the cross-modal information exchange. Even when training for one direction (e.g., video-to-audio), both modality paths receive enriched activations, which improves the quality of the generated output.

FIG. 5 is a block diagram illustrating an example DiT block 502 with conditioning based on a text input or other further input 232. The DiT block 502 extends the functionality of the DiT blocks 306 and/or DiT blocks 312 described in FIG. 3 by incorporating mechanisms to process and integrate a further input 232 into the cross-modal conditioning process.

The further input 232 is received by an embedding block 506, which encodes the further input into a format suitable for processing within the DiT block 502. In some examples, when the further input 232 is text, the embedding block 506 may implement a T5 encoder to transform the text into vector representations that capture semantic meaning:

### Embedding(text) =T5encoder(text)

The encoded representations from the embedding block 506 are then provided to a cross attention block 504 of the DiT block 502. The cross attention block 504 enables the model to condition the output on the further input 232 by allowing the modality tokens to attend to the embedded further input 232 tokens.

When the further input 232 is text, this architecture enables text-guided generation, allowing users to provide textual descriptions that influence the cross-modal generation process. For example, when generating audio from video, a text prompt could specify the type of audio to generate (e.g., “dramatic orchestral music” or “nature sounds”).

This architecture may be particularly useful and straightforward to implement because the DiT blocks in both modality paths may have been pretrained to generate content based on text prompts. By incorporating text conditioning through the cross attention block 504, the DiT block 502 leverages this pretrained capability without requiring additional training processes.

FIG. 6 is a flowchart illustrating a method 600 for generating temporally-aligned cross-modal content.

In some examples, the method 600 can be implemented using the temporally-aligned multi-modal diffusion model 222 shown in FIG. 2C and the fusion blocks 318 shown in FIG. 3 through FIG. 5, it should be understood that the operations of the method 600 can be performed by other suitable systems and components. The method 600 represents a generalized approach to cross-modal generation that may be implemented in various ways and is not limited to the specific model architectures previously described.

The method 600 begins with operation 602, which involves obtaining a first modality input. This first modality input may correspond to the first modality input 228 in the temporally-aligned multi-modal diffusion model 222 of FIG. 2C. In some examples, the first modality input is video data when performing video-to-audio generation, or audio data when performing audio-to-video generation.

In operation 604, the method combines the first modality input with noise to generate a noised input. This operation 604 corresponds to applying a small amount of noise to the first modality input 228 to generate a first modality noised input 316 as shown in FIG. 3. The noise level is specifically selected to preserve details in the input that are relevant for cross-modal alignment. For example, when the first modality is video, a small amount of noise is applied to preserve visual details that may determine significant variations in the audio output.

Operation 606 involves processing the noised input by a multi-modal diffusion model. This operation corresponds to processing the first modality noised input 316 through the temporally-aligned multi-modal diffusion model 222 shown in FIG. 3. The processing includes passing the noised input through the first modality path 304 and the second modality path 302, with fusion blocks 318 establishing temporal correspondence between the activations of both modalities.

During this processing, the fusion blocks 318 receive first modality activations 416 from DiT blocks 312 of the first modality path 304 and second modality activations 418 from DiT blocks 306 of the second modality path 302. The fusion blocks 318 establish temporal correspondence between these activations using rotary position embeddings (RoPE) that bias tokens corresponding to the same temporal position to preferentially exchange information. The modified activations are then provided back to subsequent DiT blocks in both paths through the symmetric feature reinjection mechanism.

Finally, in operation 608, the method 600 generates a second modality output that is temporally aligned with the first modality input. This operation corresponds to the output block 308 of the second modality path 302 generating the generated second modality output 234 as shown in FIG. 3. The temporal alignment ensures that events in the generated output (such as sounds in generated audio or visual elements in generated video) are synchronized with corresponding events in the input.

FIG. 7 is a flowchart illustrating a detailed implementation of operation 606 of the method 600 of FIG. 6 for generating temporally-aligned cross-modal content using fusion blocks. The sub-operations of operation 606 shown in FIG. 7 provide a more detailed view of how the multi-modal diffusion model processes the noised input.

The operation 606 begins with operation 702, which involves receiving a noised input at a first modality path. This operation corresponds to the first modality noised input 316 being received at the first modality path 304 of the temporally-aligned multi-modal diffusion model 222 shown in FIG. 3. The noise level of the first modality noised input 316 is kept constant throughout multiple iterations, with the same first modality noised input 316 being re-used for each iteration of the de-noising process. For video-to-audio generation, the constant noise level applied to the conditioning first modality (video) input can be between 0.94 and 0.98, such as 0.96, where 1.0 corresponds to zero noise. According to experimental testing of examples described herein, these values help to preserve high-frequency visual details that determine significant variations in the audio output. For audio-to-video generation, the constant noise applied to the audio input according to experimental testing may be between 0.75 and 0.85, such as 0.8, with empirical testing showing that these values provide the best balance between preserving audio details and generating corresponding visual elements.

In operation 708, the model generates first modality activations 416 by one or more DiT blocks 312 of the first modality path 304. These activations represent the encoded features of the first modality input 228 (e.g., received as the first modality noised input 316) after being processed through one or more DiT blocks and/or one or more fusion blocks of the model.

Operation 704 involves generating second modality activations by one or more DiT blocks of a second modality path. This operation corresponds to the DiT blocks 306 of the second modality path 302 processing the second modality noise input 224 to generate second modality activations 418. As described above, the second modality noise input 224 may be pure Gaussian noise or another random or pseudo-random data input in the second modality format.

In operation 706, at a fusion block, the model establishes temporal correspondence between the first modality activations and second modality activations to generate modified first modality activations and modified second modality activations. This operation corresponds to the fusion block 318 receiving the first modality activations 416 and second modality activations 418, and processing them through a series of operations including modulation, projection, RoPE temporal alignment, and self-attention, to generate the modified first modality activations 420 and modified second modality activations 422.

Operation 710 involves providing the modified first modality activations to a DiT block of the first modality path and the modified second modality activations to a DiT block of the second modality path. This operation corresponds to the feature reinjection blocks 414 of the fusion block 318 providing the modified first modality activations 420 to a subsequent DiT block 312 of the first modality path 304, and the modified second modality activations 422 to a subsequent DiT block 306 of the second modality path 302.

Operation 708 through operation 710 are repeated for each set of one or more DiT blocks in each path and for each interleaved fusion block, until activations are generated by the final DiT blocks at the output end of the model.

At operation 712, the model or an associated inference component controlling the model inference determines whether sampling or de-noising of the second modality output is finished. In some examples, a timestep or counter of diffusion iterations is maintained and incremented, and the number of iterations to be performed is predetermined. In some examples, the predetermined number of iterations is based on complete de-noising of the generated output, corresponding to a flow time of the second modality data transitioning from 0.0 to 1.0.

If sampling is not yet complete, the flowchart iterates back to operation 708 to continue the diffusion process on the DiT output. This iteration continues through all DiT blocks of both modality paths, with fusion blocks interleaved at regular intervals.

If sampling is complete, indicating that a final iteration of the diffusion process has been completed, the inference process proceeds to operation 608, which involves generating a second modality output temporally aligned with the first modality input. This operation corresponds to the output block 308 of the second modality path 302 generating the generated second modality output 234 as shown in FIG. 3.

The iterative nature of the process, indicated by the loop from operation 712 back to operation 708, allows for progressive refinement of the cross-modal alignment through multiple passes through the fusion blocks. This helps to ensure that the temporal correspondence between the first and second modality is continuously improved throughout the diffusion process.

FIG. 8 is a flowchart illustrating a method 800 for training a multi-modal diffusion model, according to some examples. Whereas examples are described with reference to the temporally-aligned multi-modal diffusion model 222 of FIG. 2C through FIG. 5, it will be appreciated that this training method 800 can potentially be applied to other model architectures and types.

The method 800 begins with operation 802, which involves obtaining a training dataset comprising first modality training data samples and corresponding, temporally-aligned second modality training data samples. This operation corresponds to collecting paired audio-video data where the audio and video tracks are temporally aligned with each other. For example, the training dataset may include videos from VGGSounds and the temporally-strong AudioSet dataset, which contain audio-video clips with strong audio-visual alignment.

In operation 804, a first noise level is applied to the first modality training data samples. This operation 804 involves adding a small amount of noise to the conditioning modality (e.g., video for V2A training or audio for A2V training). The first noise level is specifically selected to be lower than the second noise level applied to the second modality, described below. This is because the conditioning modality needs to preserve details that are relevant for cross-modal alignment. For example, when training a V2A model, a small amount of noise is applied to the video input to preserve visual details that may determine significant variations in the audio output.

Operation 806 involves applying a second noise level to the second modality training data samples. This operation adds a higher level of noise to the modality being generated (e.g., audio for V2A training or video for A2V training). The second noise level is higher than the first noise level because the model is being trained to predict the clean output from a noisy input. This asymmetric noise application is crucial for the model to learn how to leverage the conditioning modality effectively.

The reason for applying different noise levels is related to how the diffusion models work. In some examples, the video generative DiT model was pretrained with noisy videos. As a result, providing a video that is slightly noisy improves the performance of the DiT blocks.

In operation 808, the multi-modal diffusion model is trained by supervised learning using the training dataset. In some examples, the training process uses a standard diffusion loss function, wherein the complete multi-modal model (e.g., the temporally-aligned multi-modal diffusion model 222) is trained to predict the clean signal from the noised input. For V2A training, the mathematical formulation of this loss function is:

L=E[tₐ, tᵥ, A₁,V₁,A₀]∥G_{V2A}(Aₜₐ, Vₜᵥ, tₐ, tᵥ)−(A₁−A₀)∥²₂,

tₐ~pₜₐ, tᵥ~pₜᵥ, A₁,V₁~D_{AV}, A₀ ~pₙ

where tₐ and tᵥ are noise timesteps for audio and video respectively, A₁ and V₁ are the clean audio and video samples, A₀ is the Gaussian noise added to the audio, and G_{V2A} is the V2A generator function. A symmetric corresponding loss function can be used for A2V training.

Operation 810 involves maintaining constant values of pretrained parameters of the DiT blocks of the first modality path and second modality path during the supervised learning operation 808. Freezing the weights of the pretrained DiT blocks ensures that the pretrained capabilities of the audio and video models are preserved. By keeping these parameters frozen, the model avoids degrading the quality of the individual modality generators and allows for faster training.

Finally, in operation 812, the learnable parameters of the fusion blocks 318 are adjusted during supervised learning. The adjustment can be according to any known machine learning technique, e.g., stochastic gradient descent. Only the parameters of the fusion blocks 318 are updated during training, which allows the model to learn how to establish temporal correspondence between the two modalities without affecting the pretrained capabilities of the individual modality generators.

For training both A2V and V2A models, the same architecture and methodology can be used, but with different sets of fusion block parameters. While it is possible to train a single model to perform both tasks, empirical results have shown that training separate models for A2V and V2A may yield better performance.

In some examples, however, it may be possible to train a joint model that can perform both A2V and V2A tasks. In such cases, the training process can involve using different subsets of training samples for each direction, and running alternating training iterations for each direction of generation. This approach can help to ensure that the model learns both tasks effectively without conflating the different noise levels required for each direction.

FIG. 9 is a perspective view of a head-worn XR device (e.g., a display system 900 shown as XR glasses), in accordance with some examples. The display system 900, in this instance, can be worn to view augmented or virtual content displayed over real content visible in a content interaction system.

The display system 900 can include a frame 902 made from any suitable material such as plastic or metal, including any suitable shape memory alloy, as is well known for ophthalmic eyewear. In one or more examples, the frame 902 includes a first or left optical element holder 904 (e.g., a display or lens holder) and a second or right optical element holder 906 (e.g., a display or lens holder) connected by a bridge 912. A first or left optical element 908 and a second or right optical element 910 can be provided within respective left optical element holder 904 and right optical element holder 906. The right optical element 910 and the left optical element 908 can be a lens, a display, a display assembly, or a combination of the foregoing. Any suitable display assembly can be provided in the display system 900. The right optical element 910 and the left optical element 908 can each be considered to provide a display configured to present an image at a virtual image surface having a plurality of virtual image surface locations, as described below with reference to FIG. 10.

The frame 902 additionally includes a left arm or temple piece 922 and a right arm or temple piece 924. In some examples the frame 902 can be formed from a single piece of material so as to have a unitary or integral construction.

In some examples, some of the optical elements, such as the projector, waveguide, and other components of the display system 900 are mounted in a separately assembled optical support system. The optical support system includes a monocular chassis that integrates optical components such as the projector, waveguide, and other components into a single sub-assembly. In some examples, the optical support system is provided as a sub-assembly in two versions, left handed and right handed that make up a binocular pair and can be installed into the frame 902, for example into the first or left optical element holder 904 and the second or right optical element holder 906, respectively.

The display system 900 can include a computing device, such as a computer 920 having a processor and a memory storing instructions for execution by the processor. The computer 920 can be of any suitable type so as to be carried by the frame 902 and, in one or more examples, of a suitable size and shape so as to be partially disposed in one of the left temple piece 922 or the right temple piece 924. The computer 920 can include one or more processors with memory, wireless communication circuitry, and a power source. Various other examples may include these elements in different configurations or integrated together in different ways. In some examples, the computer 920 can be implemented by a machine 1500 or machine 1604 as described below with reference to FIG. 15 or FIG. 16.

The computer 920 additionally includes a battery 918 or other suitable portable power supply. In some examples, the battery 918 is disposed in the left temple piece 922 and is electrically coupled to the computer 920 disposed in the right temple piece 924, or vice versa. The display system 900 can include a connector or port (not shown) suitable for charging the battery 918, a wireless receiver, transmitter or transceiver (not shown), or a combination of such devices.

The display system 900 can include a first or left camera 914 and a second or right camera 916. Although two cameras are depicted, other examples contemplate the use of a single or additional (i.e., more than two) cameras. In one or more examples, the display system 900 can include any number of input sensors or other input/output devices in addition to the left camera 914 and the right camera 916, such as location sensors, motion sensors, and so forth. It will be appreciated that the cameras 914, 916 are a form of optical sensor, and that the display system 900 can include additional types of optical sensors in some examples.

FIG. 10 illustrates the display system 900 from the perspective of a user. For clarity, a number of the elements shown in FIG. 9 have been omitted. As described in FIG. 9, the display system 900 shown in FIG. 10 includes left optical element 908 and right optical element 910 secured within the left optical element holder 904 and the right optical element holder 906, respectively.

The display system 900 include right forward optical assembly 1002 comprising a right projector 1004 and a right display device 1006, and a left forward optical assembly 1008 including a left projector 1010 and a left display device 1012. The right forward optical assembly 1002 (with or without right optical element 910) may be referred to herein as a right near-eye display, the left forward optical assembly 1008 (with or without left optical element 908) may be referred to herein as a left near-eye display, and each may be referred to herein as a near-eye display or a near-eye optical see-through XR display.

In some examples, the right display devices 1006 are waveguides. The waveguides include reflective or diffractive structures (e.g., gratings, holograms and/or optical elements such as mirrors, lenses, or prisms). Projected light emitted by the right projector 1004 encounters the diffractive structures of the waveguide of the right display device 1006, which directs the light towards the right eye of a user to provide an image (e.g., a right-eye image) on or in the right optical element 910 that overlays the view of the real world seen by the user. Similarly, projected light emitted by the left projector 1010 encounters the diffractive structures of the waveguide of the left display device 1012, which directs the light towards the left eye of a user to provide an image (e.g., a left-eye image) on or in the left optical element 908 that overlays the view of the real world seen by the user. The combination of a graphics processing unit (GPU), the right forward optical assembly 1002, the left forward optical assembly 1008, the left optical element 908, and the right optical element 910 provide an optical engine of the display system 900. The display system 900 uses the optical engine to generate an overlay of the real world view of the user, including display of a 3D user interface to the user of the display system 900. The surface of the optical element 908 or 910 from which the projected light exits toward the user's eye is referred to as a user-facing surface, an image presentation surface, an eye-side surface, an eye-facing surface, or a display surface of the near-eye optical see-through XR display, whereas the opposite side of the optical element 908 or 910 may be referred to as a world-side surface or world-facing surface. The light exits the image presentation surface of the waveguide at one or more exit pupil locations; at each exit pupil location, the different portions of the image exit at different angles. As a result of the angles at which the light exits the exit pupils toward the user's eye, the image is perceived by a user as extending across a surface in space, referred to herein as a virtual image surface. The virtual image surface is a surface in physical space where the user's eyes converge and focus to view the image; thus, the position and shape of the virtual image surface is a function of the physical properties of the light propagating from the waveguide surface toward the user's eyes.

It will be appreciated that other display technologies or configurations may be utilized within an optical engine to display an image to a user in the user's field of view. For example, instead of a projector 1004 and a waveguide, a liquid crystal display (LCD), light emitting diode (LED) array, or other display type may be provided. In some examples, one or more liquid crystal on silicon (LCOS) panels can be used to modulate reflection of light of one or more colors to define individual pixels of the images presented by each display and thereby propagate the colors of light forming the images to various locations across one or more virtual image surfaces. In some examples, one or more LED arrays can be used to emit light of one or more colors from each of an array of LED pixels, thereby propagating the light of one or more colors to various display surface locations. In display types using a conventional 2D screen to present light toward the user's eyes, the virtual image surface can be considered to be identical to the 2D surface of the screen.

In use, a user of the display system 900 will be presented with information, content, and various 3D user interfaces on the near eye displays. The user can then interact with the display system 900 using various input modalities, including the buttons 926, voice inputs or touch inputs on an associated device, and/or hand movements, locations, and positions detected by the display system 900. In some examples, the display system 900 can include additional input devices, such as microphones, touchpads, optical or depth sensors used for gesture recognition, an inertial measurement unit (IMU) used for head motion detection, and so on.

FIG. 11 shows a perspective view of a projector 1104 emitting projected light 1110 (represented in FIG. 11 as a single ray) into a display device 1106. The simplified diagram of FIG. 11 illustrates principles that can be used to implement waveguide-based displays, such as those used by the display system 900.

The display device 1106 includes a waveguide 1102 or light guide. The waveguide 1102 guides light via repeated total internal reflections from opposing surfaces of the waveguide 1102. In the configuration of FIG. 11, the waveguide 1102 can be configured as a planar waveguide or a slab waveguide, such as disposed in the x-y plane. The surfaces can be generally flat or planar surfaces that are parallel to each other and extend in the x-y plane, although in some cases the surface may exhibit curvature. One of the surfaces (e.g., a display surface 1120) can face an eye 1108 of the user. The other of the surfaces (e.g., an opposite surface 1122, also referred to as the world-facing surface) can face away from the eye 1108 of the user.

The waveguide 1102 can include one or more diffractive and/or reflective structures, which can receive the projected light 1110 from the projector 1104, redirect the projected light 1110 internally within the waveguide 1102, and extract the projected light 1110 from the waveguide 1102 to form exiting light 1112. For example, the waveguide 1102 can include one or more diffraction gratings and/or diffraction grating regions, such as a single diffraction grating structure that has individual regions that can function as if they were separate diffraction gratings. The waveguide 1102 can include one or more reflective structures, such as mirrors, prisms, and/or reflective gratings. The waveguide 1102 can include one or more transmissive structures, such as transmissive gratings. The waveguide 1102 can include one or more light-focusing (or collimating-changing) optical elements, such as lenses. Any or all of these structures or elements can be included on one or both surfaces of the waveguide 1102 or in an interior of the waveguide 1102.

In the configuration of FIG. 11, the waveguide 1102 can include an input grating 1114, which can receive the projected light 1110 from the projector 1104 and direct the projected light 1110 into the waveguide 1102 to form light 1118. The waveguide 1102 can include an output grating 1116, which can receive the light 1118, split and redirect the light 1118 internally to extend over a relatively large area (compared to the input grating 1114), and direct the light 1118 out of the waveguide 1102 to form the exiting light 1112. The terms “grating” or “diffraction grating” are used herein to refer to any pattern of diffractive structures or diffractive features. In some examples, the input grating 1114 can be replaced with any component that couples light into the waveguide 1102 such that the light propagates within the waveguide 1102 by total internal reflection. The redirections and splitting can occur from multiple (sequential) interactions with a single diffraction grating, or from sequential interactions with different gratings that are disposed within the surface area of the output grating 1116. For example, a light ray can be diffracted into the waveguide 1102 by the input grating 1114 and be caused to totally internally reflect from one surface of the waveguide 1102 to the other in a direction toward the output grating 1116. The light 1118 can then interact with diffractive features of the output grating 1116 on or within the waveguide 1102. A portion of light 1118 is diffracted laterally within the plane of the waveguide 1102 thereby replicating the image across the area of the output grating 1116, due to multiple interactions with diffractive features that exist across the output grating 1116. Another portion of light 1118 is directed out of the waveguide by diffraction grating 1116 toward the eye 1108 as light 1112. The interactions with the diffractive features of the output grating 1116 can cause internal rays or internal light beams in the waveguide 1102 to change direction within the waveguide 1102. Eventually, the interactions with the diffractive features can cause the internal rays or internal light beams to exit the waveguide 1102 to propagate toward the eye 1108 of the user.

In some examples, the waveguide 1102 can be configured to operate at infinite conjugates. For example, the projector 1104 can project light that forms an image infinitely far away, so that the light would appear in focus on a screen placed relatively far from the projector 1104. Similarly, the output grating 1116 can direct the exiting light 1112 toward the eye in such a manner that the image appears to be infinitely far away to the eye 1108 of the user. For such an infinite-conjugate arrangement, angles in the space of the light that enters and exits the waveguide 1102 can correspond uniquely to image locations in the image. For example, the propagation angles of the light can map uniquely to the propagation angles of the exiting light 1112, which in turn can map uniquely to the image locations in the image at the retina of the eye 1108 of the user.

The waveguide 1102 can make use of this infinite-conjugate relationship to perform so-called “pupil replication” or “pupil expansion”. The projector 1104 can be configured to have an exit pupil that coincides with the input grating 1114. The internal splitting and redirections within the output grating 1116 can effectively expand a surface area of the exit pupil, while maintaining the unique mapping of propagation angle to image location for light in the pupil, and thereby maintaining the unique mapping of virtual image surface location to image location. The size of the output grating 1116 (e.g., an area covered by the replicated pupils, as constrained within a surface area of the output grating 1116) can be larger than a pupil of the eye 1108 of the user, so that if the pupil of the eye 1108 moves, such as caused by the user changing a gaze direction, the amount of light entering the pupil of the eye 1108 may not vary significantly, and the user may not perceive a change in brightness of the image.

### Networked Computing Environment

FIG. 12 is a block diagram showing an example digital interaction system 1200 for facilitating interactions and engagements (e.g., exchanging text messages, conducting text audio and video calls, or playing games) over a network. The digital interaction system 1200 includes multiple user systems 1202, each of which hosts multiple applications, including an interaction client 1204 and other applications 1206. Each interaction client 1204 is communicatively coupled, via one or more networks including a Network 1208 (e.g., the Internet), to other instances of the interaction client 1204 (e.g., hosted on respective other user systems 1202), a server system 1210 and third-party servers 1212). An interaction client 1204 can also communicate with locally hosted applications 1206 using Applications Program Interfaces (APIs).

Each user system 1202 may include multiple user devices, such as a mobile device 1214, head-wearable apparatus 1216 (such as display system 900), and a computer client device 1218 that are communicatively connected to exchange data and messages.

An interaction client 1204 interacts with other interaction clients 1204 and with the server system 1210 via the Network 1208. The data exchanged between the interaction clients 1204 (e.g., interactions 1220) and between the interaction clients 1204 and the server system 1210 includes functions (e.g., commands to invoke functions) and payload data (e.g., text, audio, video, or other multimedia data).

The server system 1210 provides server-side functionality via the Network 1208 to the interaction clients 1204. While certain functions of the digital interaction system 1200 are described herein as being performed by either an interaction client 1204 or by the server system 1210, the location of certain functionality either within the interaction client 1204 or the server system 1210 may be a design choice. For example, it may be technically preferable to initially deploy particular technology and functionality within the server system 1210 but to later migrate this technology and functionality to the interaction client 1204 where a user system 1202 has sufficient processing capacity.

The server system 1210 supports various services and operations that are provided to the interaction clients 1204. Such operations include transmitting data to, receiving data from, and processing data generated by the interaction clients 1204. This data may include message content, client device information, geolocation information, digital effects (e.g., media augmentation and overlays), message content persistence conditions, entity relationship information, and live event information. Data exchanges within the digital interaction system 1200 are invoked and controlled through functions available via user interfaces (UIs) of the interaction clients 1204.

Turning now specifically to the server system 1210, an Application Program Interface (API) server 1222 is coupled to and provides programmatic interfaces to servers 1224, making the functions of the servers 1224 accessible to interaction clients 1204, other applications 1206 and third-party server 1212. The servers 1224 are communicatively coupled to a database server 1226, facilitating access to a database 1228 that stores data associated with interactions processed by the servers 1224. Similarly, a web server 1230 is coupled to the servers 1224 and provides web-based interfaces to the servers 1224. To this end, the web server 1230 processes incoming network requests over the Hypertext Transfer Protocol (HTTP) and several other related protocols.

The Application Program Interface (API) server 1222 receives and transmits interaction data (e.g., commands and message payloads) between the servers 1224 and the user systems 1202 (and, for example, interaction clients 1204 and other application 1206) and the third-party server 1212. Specifically, the Application Program Interface (API) server 1222 provides a set of interfaces (e.g., routines and protocols) that can be called or queried by the interaction client 1204 and other applications 1206 to invoke functionality of the servers 1224. The Application Program Interface (API) server 1222 exposes various functions supported by the servers 1224, including account registration; login functionality; the sending of interaction data, via the servers 1224, from a particular interaction client 1204 to another interaction client 1204; the communication of media files (e.g., images or video) from an interaction client 1204 to the servers 1224; the settings of a collection of media data (e.g., a narrative); the retrieval of a list of friends of a user of a user system 1202; the retrieval of messages and content; the addition and deletion of entities (e.g., friends) to an entity relationship graph; the location of friends within an entity relationship graph; and opening an application event (e.g., relating to the interaction client 1204).

The servers 1224 host multiple systems and subsystems, described below with reference to FIG. 13.

### External Recources and Linked Applications

The interaction client 1204 provides a user interface that allows users to access features and functions of an external resource, such as a linked application 1206, an applet, or a microservice. This external resource may be provided by a third party or by the creator of the interaction client 1204.

The external resource may be a full-scale application installed on the user's system 1202, or a smaller, lightweight version of the application, such as an applet or a microservice, hosted either on the user's system or remotely, such as on third-party servers 1212 or in the cloud. These smaller versions, which include a subset of the full application's features, may be implemented using a markup-language document and may also incorporate a scripting language and a style sheet.

When a user selects an option to launch or access the external resource, the interaction client 1204 determines whether the resource is web-based or a locally installed application. Locally installed applications can be launched independently of the interaction client 1204, while applets and microservices can be launched or accessed via the interaction client 1204.

If the external resource is a locally installed application, the interaction client 1204 instructs the user's system to launch the resource by executing locally stored code. If the resource is web-based, the interaction client 1204 communicates with third-party servers to obtain a markup-language document corresponding to the selected resource, which it then processes to present the resource within its user interface.

The interaction client 1204 can also notify users of activity in one or more external resources. For instance, it can provide notifications relating to the use of an external resource by one or more members of a user group. Users can be invited to join an active external resource or to launch a recently used but currently inactive resource.

The interaction client 1204 can present a list of available external resources to a user, allowing them to launch or access a given resource. This list can be presented in a context-sensitive menu, with icons representing different applications, applets, or microservices varying based on how the menu is launched by the user.

### System Architecture

FIG. 13 is a block diagram illustrating further details regarding the digital interaction system 1200, according to some examples. Specifically, the digital interaction system 1200 is shown to comprise the interaction client 1204 and the servers 1224. The digital interaction system 1200 embodies multiple subsystems, which are supported on the client-side by the interaction client 1204 and on the server-side by the servers 1224. In some examples, these subsystems are implemented as microservices. A microservice subsystem (e.g., a microservice application) may have components that enable it to operate independently and communicate with other services. Example components of microservice subsystem may include:
Function logic: The function logic implements the functionality of the microservice subsystem, representing a specific capability or function that the microservice provides.
API interface: Microservices may communicate with each other components through well-defined APIs or interfaces, using lightweight protocols such as REST or messaging. The API interface defines the inputs and outputs of the microservice subsystem and how it interacts with other microservice subsystems of the digital interaction system 1200.
Data storage: A microservice subsystem may be responsible for its own data storage, which may be in the form of a database, cache, or other storage mechanism (e.g., using the database server 1226 and database 1228). This enables a microservice subsystem to operate independently of other microservices of the digital interaction system 1200.
Service discovery: Microservice subsystems may find and communicate with other microservice subsystems of the digital interaction system 1200. Service discovery mechanisms enable microservice subsystems to locate and communicate with other microservice subsystems in a scalable and efficient way.
Monitoring and logging: Microservice subsystems may need to be monitored and logged to ensure availability and performance. Monitoring and logging mechanisms enable the tracking of health and performance of a microservice subsystem.

In some examples, the digital interaction system 1200 may employ a monolithic architecture, a service-oriented architecture (SOA), a function-as-a-service (FaaS) architecture, or a modular architecture:

Example subsystems are discussed below.

An image processing system 1302 provides various functions that enable a user to capture and modify (e.g., augment, annotate or otherwise edit) media content associated with a message.

A camera system 1304 includes control software (e.g., in a camera application) that interacts with and controls hardware camera hardware (e.g., directly or via operating system controls) of the user system 1202 to modify real-time images captured and displayed via the interaction client 1204.

The digital effect system 1306 provides functions related to the generation and publishing of digital effects (e.g., media overlays) for images captured in real-time by cameras of the user system 1202 or retrieved from memory of the user system 1202. For example, the digital effect system 1306 operatively selects, presents, and displays digital effects (e.g., media overlays such as image filters or modifications) to the interaction client 1204 for the modification of real-time images received via the camera system 1304 or stored images retrieved from memory 1402 of a user system 1202. These digital effects are selected by the digital effect system 1306 and presented to a user of an interaction client 1204, based on a number of inputs and data, such as for example:
Geolocation of the user system 1202; and
Entity relationship information of the user of the user system 1202.

Digital effects may include audio and visual content and visual effects. Examples of audio and visual content include pictures, texts, logos, animations, and sound effects. Examples of visual effects include color overlays and media overlays. The audio and visual content or the visual effects can be applied to a media content item (e.g., a photo or video) at user system 1202 for communication in a message, or applied to video content, such as a video content stream or feed transmitted from an interaction client 1204. As such, the image processing system 1302 may interact with, and support, the various subsystems of the communication system 1308, such as the messaging system 1310 and the video communication system 1312.

A media overlay may include text or image data that can be overlaid on top of a photograph taken by the user system 1202 or a video stream produced by the user system 1202. In some examples, the media overlay may be a location overlay (e.g., Venice beach), a name of a live event, or a name of a merchant overlay (e.g., Beach Coffee House). In further examples, the image processing system 1302 uses the geolocation of the user system 1202 to identify a media overlay that includes the name of a merchant at the geolocation of the user system 1202. The media overlay may include other indicia associated with the merchant. The media overlays may be stored in the databases 1228 and accessed through the database server 1226.

The image processing system 1302 provides a user-based publication platform that enables users to select a geolocation on a map and upload content associated with the selected geolocation. The user may also specify circumstances under which a particular media overlay should be offered to other users. The image processing system 1302 generates a media overlay that includes the uploaded content and associates the uploaded content with the selected geolocation.

The digital effect creation system 1314 supports augmented reality developer platforms and includes an application for content creators (e.g., artists and developers) to create and publish digital effects (e.g., augmented reality experiences) of the interaction client 1204. The digital effect creation system 1314 provides a library of built-in features and tools to content creators including, for example custom shaders, tracking technology, and templates.

In some examples, the digital effect creation system 1314 provides a merchant-based publication platform that enables merchants to select a particular digital effect associated with a geolocation via a bidding process. For example, the digital effect creation system 1314 associates a media overlay of the highest bidding merchant with a corresponding geolocation for a predefined amount of time.

A communication system 1308 is responsible for enabling and processing multiple forms of communication and interaction within the digital interaction system 1200 and includes a messaging system 1310, an audio communication system 1316, and a video communication system 1312. The messaging system 1310 is responsible, in some examples, for enforcing the temporary or time-limited access to content by the interaction clients 1204. The messaging system 1310 incorporates multiple timers that, based on duration and display parameters associated with a message or collection of messages (e.g., a narrative), selectively enable access (e.g., for presentation and display) to messages and associated content via the interaction client 1204. The audio communication system 1316 enables and supports audio communications (e.g., real-time audio chat) between multiple interaction clients 1204. Similarly, the video communication system 1312 enables and supports video communications (e.g., real-time video chat) between multiple interaction clients 1204.

A user management system 1318 is operationally responsible for the management of user data and profiles, and maintains entity information regarding users and relationships between users of the digital interaction system 1200.

A collection management system 1320 is operationally responsible for managing sets or collections of media (e.g., collections of text, image video, and audio data). A collection of content (e.g., messages, including images, video, text, and audio) may be organized into an “event gallery” or an “event collection.” Such a collection may be made available for a specified time period, such as the duration of an event to which the content relates. For example, content relating to a music concert may be made available as a “concert collection” for the duration of that music concert. The collection management system 1320 may also be responsible for publishing an icon that provides notification of a particular collection to the user interface of the interaction client 1204. The collection management system 1320 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 1320 employs machine vision (or image recognition technology) and content rules to curate a content collection automatically. In certain examples, compensation may be paid to a user to include user-generated content into a collection. In such cases, the collection management system 1320 operates to automatically make payments to such users to use their content.

A map system 1322 provides various geographic location (e.g., geolocation) functions and supports the presentation of map-based media content and messages by the interaction client 1204. For example, the map system 1322 enables the display of user icons or avatars on a map to indicate a current or past location of “friends” of a user, as well as media content (e.g., collections of messages including photographs and videos) generated by such friends, within the context of a map. For example, a message posted by a user to the digital interaction system 1200 from a specific geographic location may be displayed within the context of a map at that particular location to “friends” of a specific user on a map interface of the interaction client 1204. A user can furthermore share his or her location and status information (e.g., using an appropriate status avatar) with other users of the digital interaction system 1200 via the interaction client 1204, with this location and status information being similarly displayed within the context of a map interface of the interaction client 1204 to selected users.

A game system 1324 provides various gaming functions within the context of the interaction client 1204. The interaction client 1204 provides a game interface providing a list of available games that can be launched by a user within the context of the interaction client 1204 and played with other users of the digital interaction system 1200. The digital interaction system 1200 further enables a particular user to invite other users to participate in the play of a specific game by issuing invitations to such other users from the interaction client 1204. The interaction client 1204 also supports audio, video, and text messaging (e.g., chats) within the context of gameplay, provides a leaderboard for the games, and supports the provision of in-game rewards (e.g., coins and items).

An external resource system 1326 provides an interface for the interaction client 1204 to communicate with remote servers (e.g., third-party servers 1212) to launch or access external resources, i.e., applications or applets. Each third-party server 1212 hosts, for example, a markup language (e.g., HTML5) based application or a small-scale version of an application (e.g., game, utility, payment, or ride-sharing application). The interaction client 1204 may launch a web-based resource (e.g., application) by accessing the HTML5 file from the third-party servers 1212 associated with the web-based resource. Applications hosted by third-party servers 1212 are programmed in JavaScript leveraging a Software Development Kit (SDK) provided by the servers 1224. The SDK includes Application Programming Interfaces (APIs) with functions that can be called or invoked by the web-based application. The servers 1224 host a JavaScript library that provides a given external resource access to specific user data of the interaction client 1204. HTML5 is an example of technology for programming games, but applications and resources programmed based on other technologies can be used.

To integrate the functions of the SDK into the web-based resource, the SDK is downloaded by the third-party server 1212 from the servers 1224 or is otherwise received by the third-party server 1212. Once downloaded or received, the SDK is included as part of the application code of a web-based external resource. The code of the web-based resource can then call or invoke certain functions of the SDK to integrate features of the interaction client 1204 into the web-based resource.

The SDK stored on the server system 1210 effectively provides the bridge between an external resource (e.g., applications 1206 or applets) and the interaction client 1204. This gives the user a seamless experience of communicating with other users on the interaction client 1204 while also preserving the look and feel of the interaction client 1204. To bridge communications between an external resource and an interaction client 1204, the SDK facilitates communication between third-party servers 1212 and the interaction client 1204. A bridge script running on a user system 1202 establishes two one-way communication channels between an external resource and the interaction client 1204. Messages are sent between the external resource and the interaction client 1204 via these communication channels asynchronously. Each SDK function invocation is sent as a message and callback. Each SDK function is implemented by constructing a unique callback identifier and sending a message with that callback identifier.

By using the SDK, not all information from the interaction client 1204 is shared with third-party servers 1212. The SDK limits which information is shared based on the needs of the external resource. Each third-party server 1212 provides an HTML5 file corresponding to the web-based external resource to servers 1224. The servers 1224 can add a visual representation (such as a box art or other graphic) of the web-based external resource in the interaction client 1204. Once the user selects the visual representation or instructs the interaction client 1204 through a GUI of the interaction client 1204 to access features of the web-based external resource, the interaction client 1204 obtains the HTML5 file and instantiates the resources to access the features of the web-based external resource.

The interaction client 1204 presents a graphical user interface (e.g., a landing page or title screen) for an external resource. During, before, or after presenting the landing page or title screen, the interaction client 1204 determines whether the launched external resource has been previously authorized to access user data of the interaction client 1204. In response to determining that the launched external resource has been previously authorized to access user data of the interaction client 1204, the interaction client 1204 presents another graphical user interface of the external resource that includes functions and features of the external resource. In response to determining that the launched external resource has not been previously authorized to access user data of the interaction client 1204, after a threshold period of time (e.g., 3 seconds) of displaying the landing page or title screen of the external resource, the interaction client 1204 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 1204 adds the external resource to a list of authorized external resources and allows the external resource to access user data from the interaction client 1204. The external resource is authorized by the interaction client 1204 to access the user data under an OAuth 2 framework.

The interaction client 1204 controls the type of user data that is shared with external resources based on the type of external resource being authorized. For example, external resources that include full-scale applications (e.g., an application 1206) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 1328 operationally enables the purchasing of advertisements by third parties for presentation to end-users via the interaction clients 1204 and handles the delivery and presentation of these advertisements.

An artificial intelligence and machine learning system 1330 provides a variety of services to different subsystems within the digital interaction system 1200. For example, the artificial intelligence and machine learning system 1330 operates with the image processing system 1302 and the camera system 1304 to analyze images and extract information such as objects, text, or faces. This information can then be used by the image processing system 1302 to enhance, filter, or manipulate images. The artificial intelligence and machine learning system 1330 may be used by the digital effect system 1306 to generate modified content and augmented reality experiences, such as adding virtual objects or animations to real-world images. The communication system 1308 and messaging system 1310 may use the artificial intelligence and machine learning system 1330 to analyze communication patterns and provide insights into how users interact with each other and provide intelligent message classification and tagging, such as categorizing messages based on sentiment or topic. The artificial intelligence and machine learning system 1330 may also provide chatbot functionality to message interactions 1220 between user systems 1202 and between a user system 1202 and the server system 1210. The artificial intelligence and machine learning system 1330 may also work with the audio communication system 1316 to provide speech recognition and natural language processing capabilities, allowing users to interact with the digital interaction system 1200 using voice commands. In some examples, the 1330 provides some or all of the model training and/or model inference functionality of the audio generator 106.

A compliance system 1332 facilitates compliance by the digital interaction system 1200 with data privacy and other regulations, including for example the California Consumer Privacy Act (CCPA), General Data Protection Regulation (GDPR), and Digital Services Act (DSA). The compliance system 1332 comprises several components that address data privacy, protection, and user rights, ensuring a secure environment for user data. A data collection and storage component securely handles user data, using encryption and enforcing data retention policies. A data access and processing component provides controlled access to user data, ensuring compliant data processing and maintaining an audit trail. A data subject rights management component facilitates user rights requests in accordance with privacy regulations, while the data breach detection and response component detects and responds to data breaches in a timely and compliant manner. The compliance system 1332 also incorporates opt-in/opt-out management and privacy controls across the digital interaction system 1200, empowering users to manage their data preferences. The compliance system 1332 is designed to handle sensitive data by obtaining explicit consent, implementing strict access controls and in accordance with applicable laws.

### System with Head-Wearable Apparatus

FIG. 14 illustrates a system 1400 including a head-wearable apparatus 1216 with a selector input device, according to some examples. FIG. 14 is a high-level functional block diagram of an example head-wearable apparatus 1216 communicatively coupled to a mobile device 1214 and various server systems 1404 (e.g., the server system 1210) via various Networks 1208.

The head-wearable apparatus 1216 includes one or more cameras, each of which may be, for example, a visible light camera 1406, an infrared emitter 1408, and an infrared camera 1410.

The mobile device 1214 connects with head-wearable apparatus 1216 using both a low-power wireless connection 1412 and a high-speed wireless connection 1414. The mobile device 1214 is also connected to the server system 1404 and the Network 1416.

The head-wearable apparatus 1216 further includes two image displays of the image display of optical assembly 1418. The two image displays of optical assembly 1418 include one associated with the left lateral side and one associated with the right lateral side of the head-wearable apparatus 1216. The head-wearable apparatus 1216 also includes an image display driver 1420, an image Processor 1422, low-power circuitry 1424, and high-speed circuitry 1426. The image display of optical assembly 1418 is for presenting images and videos, including an image that can include a graphical user interface to a user of the head-wearable apparatus 1216.

The image display driver 1420 commands and controls the image display of optical assembly 1418. The image display driver 1420 may deliver image data directly to the image display of optical assembly 1418 for presentation or may convert the image data into a signal or data format suitable for delivery to the image display device. For example, the image data may be video data formatted according to compression formats, such as H.264 (MPEG-4 Part 10), HEVC, Theora, Dirac, RealVideo RV40, VP8, VP9, or the like, and still image data may be formatted according to compression formats such as Portable Network Group (PNG), Joint Photographic Experts Group (JPEG), Tagged Image File Format (TIFF) or exchangeable image file format (EXIF) or the like.

The head-wearable apparatus 1216 includes a frame and stems (or temples) extending from a lateral side of the frame. The head-wearable apparatus 1216 further includes a user input device 1428 (e.g., touch sensor or push button), including an input surface on the head-wearable apparatus 1216. The user input device 1428 (e.g., touch sensor or push button) is to receive from the user an input selection to manipulate the graphical user interface of the presented image.

The components shown in FIG. 14 for the head-wearable apparatus 1216 are located on one or more circuit boards, for example a PCB or flexible PCB, in the rims or temples. Alternatively, or additionally, the depicted components can be located in the chunks, frames, hinges, or bridge of the head-wearable apparatus 1216. Left and right visible light cameras 1406 can include digital camera elements such as a complementary metal oxide-semiconductor (CMOS) image sensor, charge-coupled device, camera lenses, or any other respective visible or light-capturing elements that may be used to capture data, including images of scenes with unknown objects.

The head-wearable apparatus 1216 includes a memory 1402, which stores instructions to perform a subset, or all the functions described herein. The memory 1402 can also include storage device.

As shown in FIG. 14, the high-speed circuitry 1426 includes a high-speed Processor 1430, a memory 1402, and high-speed wireless circuitry 1432. In some examples, the image display driver 1420 is coupled to the high-speed circuitry 1426 and operated by the high-speed Processor 1430 to drive the left and right image displays of the image display of optical assembly 1418. The high-speed Processor 1430 may be any processor capable of managing high-speed communications and operation of any general computing system needed for the head-wearable apparatus 1216. The high-speed Processor 1430 includes processing resources needed for managing high-speed data transfers on a high-speed wireless connection 1414 to a wireless local area network (WLAN) using the high-speed wireless circuitry 1432. In certain examples, the high-speed Processor 1430 executes an operating system such as a LINUX operating system or other such operating system of the head-wearable apparatus 1216, and the operating system is stored in the memory 1402 for execution. In addition to any other responsibilities, the high-speed Processor 1430 executing a software architecture for the head-wearable apparatus 1216 is used to manage data transfers with high-speed wireless circuitry 1432. In certain examples, the high-speed wireless circuitry 1432 is configured to implement Institute of Electrical and Electronic Engineers (IEEE) 802.11 communication standards, also referred to herein as WI-FI®. In some examples, other high-speed communications standards may be implemented by the high-speed wireless circuitry 1432.

The low-power wireless circuitry 1434 and the high-speed wireless circuitry 1432 of the head-wearable apparatus 1216 can include short-range transceivers (e.g., Bluetooth™, Bluetooth LE, Zigbee, ANT+) and wireless wide, local, or wide area Network transceivers (e.g., cellular or WI-FI®). Mobile device 1214, including the transceivers communicating via the low-power wireless connection 1412 and the high-speed wireless connection 1414, may be implemented using details of the architecture of the head-wearable apparatus 1216, as can other elements of the Network 1416.

The memory 1402 includes any storage device capable of storing various data and applications, including, among other things, camera data generated by the left and right visible light cameras 1406, the infrared camera 1410, and the image Processor 1422, as well as images generated for display by the image display driver 1420 on the image displays of the image display of optical assembly 1418. While the memory 1402 is shown as integrated with high-speed circuitry 1426, in some examples, the memory 1402 may be an independent standalone element of the head-wearable apparatus 1216. In certain such examples, electrical routing lines may provide a connection through a chip that includes the high-speed Processor 1430 from the image Processor 1422 or the low-power Processor 1436 to the memory 1402. In some examples, the high-speed Processor 1430 may manage addressing of the memory 1402 such that the low-power Processor 1436 will boot the high-speed Processor 1430 any time that a read or write operation involving memory 1402 is needed.

As shown in FIG. 14, the low-power Processor 1436 or high-speed Processor 1430 of the head-wearable apparatus 1216 can be coupled to the camera (visible light camera 1406, infrared emitter 1408, or infrared camera 1410), the image display driver 1420, the user input device 1428 (e.g., touch sensor or push button), and the memory 1402.

The head-wearable apparatus 1216 is connected to a host computer. For example, the head-wearable apparatus 1216 is paired with the mobile device 1214 via the high-speed wireless connection 1414 or connected to the server system 1404 via the Network 1416. The server system 1404 may be one or more computing devices as part of a service or network computing system, for example, that includes a processor, a memory, and network communication interface to communicate over the Network 1416 with the mobile device 1214 and the head-wearable apparatus 1216.

The mobile device 1214 includes a processor and a Network communication interface coupled to the processor. The Network communication interface allows for communication over the Network 1416, low-power wireless connection 1412, or high-speed wireless connection 1414. Mobile device 1214 can further store at least portions of the instructions in the memory of the mobile device 1214 memory to implement the functionality described herein.

Output components of the head-wearable apparatus 1216 include visual components, such as a display such as a liquid crystal display (LCD), a plasma display panel (PDP), a light-emitting diode (LED) display, a projector, or a waveguide. The image displays of the optical assembly are driven by the image display driver 1420. The output components of the head-wearable apparatus 1216 further include acoustic components (e.g., speakers), haptic components (e.g., a vibratory motor), other signal generators, and so forth. The input components of the head-wearable apparatus 1216, the mobile device 1214, and server system 1404, such as the user input device 1428, may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or other pointing instruments), tactile input components (e.g., a physical button, a touch screen that provides location and force of touches or touch gestures, or other tactile input components), audio input components (e.g., a microphone), and the like.

The head-wearable apparatus 1216 may also include additional peripheral device elements. Such peripheral device elements may include sensors and display elements integrated with the head-wearable apparatus 1216. For example, peripheral device elements may include any I/O components including output components, motion components, position components, or any other such elements described herein.

The motion components include acceleration sensor components (e.g., accelerometer), gravitation sensor components, rotation sensor components (e.g., gyroscope), and so forth. The position components include location sensor components to generate location coordinates (e.g., a Global Positioning System (GPS) receiver component), Wi-Fi or Bluetooth™ transceivers to generate positioning system coordinates, altitude sensor components (e.g., altimeters or barometers that detect air pressure from which altitude may be derived), orientation sensor components (e.g., magnetometers), and the like. Such positioning system coordinates can also be received over low-power wireless connections 1412 and high-speed wireless connection 1414 from the mobile device 1214 via the low-power wireless circuitry 1434 or high-speed wireless circuitry 1432.

### Machine Architecture

FIG. 15 is a diagrammatic representation of a machine 1500 within which instructions 1502 (e.g., software, a program, an application, an applet, an app, or other executable code) for causing the machine 1500 to perform any one or more of the methodologies discussed herein may be executed. For example, the instructions 1502 can cause the machine 1500 to implement and control the display system 900 described above. The instructions 1502 transform the general, non-programmed machine 1500 into a particular machine 1500 programmed to carry out the described and illustrated functions in the manner described. The machine 1500 can operate as a standalone device or can be coupled (e.g., networked) to other machines. In a networked deployment, the machine 1500 can operate in the capacity of a server machine or a client machine in a server-client network environment, or as a peer machine in a peer-to-peer (or distributed) network environment. The machine 1500 can comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch, a pair of augmented reality glasses), a smart home device (e.g., a smart appliance), other smart devices, a web appliance, a network router, a network switch, a network bridge, or any machine capable of executing the instructions 1502, sequentially or otherwise, that specify actions to be taken by the machine 1500. Further, while a single machine 1500 is illustrated, the term “machine” shall also be taken to include a collection or system of machines that individually or jointly execute the instructions 1502 to perform any one or more of the methodologies discussed herein. In some examples, the machine 1500 can comprise both client and server systems, with certain operations of a particular method or algorithm being performed on the server-side and with certain operations of the particular method or algorithm being performed on the client-side.

The machine 1500 can include processors 1504, memory 1506, and input/output I/O components 1508, which can be configured to communicate with each other via a bus 1510. In an example, the processors 1504 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) can include, for example, a processor 1512 and a processor 1514 that execute the instructions 1502. The term “processor” is intended to include multi-core processors that can comprise two or more independent processors (sometimes referred to as “cores”) that can execute instructions contemporaneously. Although FIG. 15 shows multiple processors 1504, the machine 1500 can include a single processor with a single-core, a single processor with multiple cores (e.g., a multi-core processor), multiple processors with a single core, multiple processors with multiples cores, or any combination thereof.

The memory 1506 includes a main memory 1516, a static memory 1518, and a storage unit 1520, all accessible to the processors 1504 via the bus 1510. The main memory 1506, the static memory 1518, and the storage unit 1520 store the instructions 1502 embodying any one or more of the methodologies or functions described herein. The instructions 1502 can also reside, completely or partially, within the main memory 1516, within the static memory 1518, within machine-readable medium 1522 within the storage unit 1520, within at least one of the processors 1504 (e.g., within the processor's cache memory), or any suitable combination thereof, during execution thereof by the machine 1500.

The I/O components 1508 can include a wide variety of components to receive input, provide output, produce output, transmit information, exchange information, capture measurements, and so on. The specific I/O components 1508 that are included in a particular machine will depend on the type of machine. For example, portable machines such as mobile phones can include a touch input device or other such input mechanisms, while a headless server machine will likely not include such a touch input device. It will be appreciated that the I/O components 1508 can include many other components that are not shown in FIG. 15. In various examples, the I/O components 1508 can include user output components 1524 and user input components 1526. The user output components 1524 can include or communicate with visual components (e.g., one or more displays such as the left near-eye display and right near-eye display, a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1526 can include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1508 can include motion components 1528, environmental components 1530, or position components 1532, among a wide array of other components.

The motion components 1528 include acceleration sensor components (e.g., accelerometer), gravitation sensor components, rotation sensor components (e.g., gyroscope).

The environmental components 1530 include, for example, one or more externally-facing cameras (with still image/photograph and video capabilities) such as left camera 914 and right camera 916, illumination sensor components (e.g., photometer or ambient light sensor), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), depth sensors (such as one or more LIDAR arrays), or other components that can provide indications, measurements, or signals corresponding to a surrounding physical environment.

Further, the camera system of the machine 1500 can include dual rear cameras (e.g., a primary camera as well as a depth-sensing camera), or even triple, quad or penta rear camera configurations on the front and rear sides of the machine 1500. These multiple cameras systems can include a wide camera, an ultra-wide camera, a telephoto camera, a macro camera, and a depth sensor, for example. In some examples, one or more of the cameras can be used as an ambient light sensor.

The position components 1532 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1508 further include communication components 1534 operable to couple the machine 1500 to a network 1536 or devices 1538 via respective coupling or connections. For example, the communication components 1534 can include a network interface component or another suitable device to interface with the network 1536. In further examples, the communication components 1534 can include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1538 can be another machine or any of a wide variety of peripheral devices (e.g., a peripheral device coupled via a USB).

Moreover, the communication components 1534 can detect identifiers or include components operable to detect identifiers. For example, the communication components 1534 can include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information can be derived via the communication components 1534, such as location via Internet Protocol (IP) geolocation, location via Wi-Fi® signal triangulation, location via detecting an NFC beacon signal that can indicate a particular location, and so forth.

The various memories (e.g., main memory 1516, static memory 1518, and memory of the processors 1504) and storage unit 1520 can store one or more sets of instructions and data structures (e.g., software) embodying or used by any one or more of the methodologies or functions described herein. These instructions (e.g., the instructions 1502), when executed by processors 1504, cause various operations to implement the disclosed examples, including the operation of the display system 900.

The instructions 1502 can be transmitted or received over the network 1536, using a transmission medium, via a network interface device (e.g., a network interface component included in the communication components 1534) and using any one of several well-known transfer protocols (e.g., hypertext transfer protocol (HTTP)). Similarly, the instructions 1502 can be transmitted or received using a transmission medium via a coupling (e.g., a peer-to-peer coupling) to the devices 1538.

### Software Architecture

FIG. 16 is a block diagram 1600 illustrating a software architecture 1602, which can be installed on any one or more of the devices described herein. The software architecture 1602 is supported by hardware such as a machine 1604 that includes processors 1606, memory 1608, and I/O components 1610. In this example, the software architecture 1602 can be conceptualized as a stack of layers, where each layer provides a particular functionality. The software architecture 1602 includes layers such as an operating system 1612, libraries 1614, frameworks 1616, and applications 1618. The applications 1618 can include the audio generator 106, and/or components thereof, as described herein. Operationally, the applications 1618 invoke API calls 1620 through the software stack and receive messages 1622 in response to the API calls 1620. The described examples, and at least some of the functions thereof, can be implemented by components in one or more layers of the software architecture 1602.

The operating system 1612 manages hardware resources and provides common services. The operating system 1612 includes, for example, a kernel 1624, services 1626, and drivers 1628. The kernel 1624 acts as an abstraction layer between the hardware and the other software layers. For example, the kernel 1624 provides memory management, processor management (e.g., scheduling), component management, networking, and security settings, among other functionalities. The services 1626 can provide other common services for the other software layers. The drivers 1628 are responsible for controlling or interfacing with the underlying hardware. For instance, the drivers 1628 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1614 provide a common low-level infrastructure used by the applications 1618. The libraries 1614 can include system libraries 1630 (e.g., C standard library) that provide functions such as memory allocation functions, string manipulation functions, mathematic functions, and the like. In addition, the libraries 1614 can include API libraries 1632 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1614 can also include a wide variety of other libraries 1634 to provide many other APIs to the applications 1618.

The frameworks 1616 provide a common high-level infrastructure that is used by the applications 1618. For example, the frameworks 1616 provide various graphical user interface (GUI) functions, high-level resource management, and high-level location services. The frameworks 1616 can provide a broad spectrum of other APIs that can be used by the applications 1618, some of which can be specific to a particular operating system or platform.

In an example, the applications 1618 can include a home application 1636, a location application 1638, and a broad assortment of other applications such as a third-party application 1640. The applications 1618 are programs that execute functions defined in the programs. Various programming languages can be employed to create one or more of the applications 1618, structured in a variety of manners, such as object-oriented programming languages (e.g., Objective-C, Java, or C++) or procedural programming languages (e.g., C or assembly language). In a specific example, the third-party application 1640 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1640 can invoke the API calls 1620 provided by the operating system 1612 to facilitate functionalities described herein.

FIG. 17 is a flowchart depicting a machine-learning pipeline 1700, according to some examples. The machine-learning pipeline 1700 may be used to generate a trained model, for example the trained machine-learning program 1800 of FIG. 18, to perform operations associated with searches and query responses.

Broadly, machine learning may involve using computer algorithms to automatically learn patterns and relationships in data, potentially without the need for explicit programming. Machine learning algorithms can be divided into three main categories: supervised learning, unsupervised learning, and reinforcement learning.
Supervised learning involves training a model using labeled data to predict an output for new, unseen inputs. Examples of supervised learning algorithms include linear regression, decision trees, and neural networks.
Unsupervised learning involves training a model on unlabeled data to find hidden patterns and relationships in the data. Examples of unsupervised learning algorithms include clustering, principal component analysis, and generative models like autoencoders.
Reinforcement learning involves training a model to make decisions in a dynamic environment by receiving feedback in the form of rewards or penalties. Examples of reinforcement learning algorithms include Q-learning and policy gradient methods.

Examples of specific machine learning algorithms that may be deployed, according to some examples, include logistic regression, which is a type of supervised learning algorithm used for binary classification tasks. Logistic regression models the probability of a binary response variable based on one or more predictor variables. Another example type of machine learning algorithm is Naïve Bayes, which is another supervised learning algorithm used for classification tasks. NaïBayes is based on Bayes' theorem and assumes that the predictor variables are independent of each other. Random Forest is another type of supervised learning algorithm used for classification, regression, and other tasks. Random Forest builds a collection of decision trees and combines their outputs to make predictions. Further examples include neural networks, which consist of interconnected layers of nodes (or neurons) that process information and make predictions based on the input data. Matrix factorization is another type of machine learning algorithm used for recommender systems and other tasks. Matrix factorization decomposes a matrix into two or more matrices to uncover hidden patterns or relationships in the data. Support Vector Machines (SVM) are a type of supervised learning algorithm used for classification, regression, and other tasks. SVM finds a hyperplane that separates the different classes in the data. Other types of machine learning algorithms include decision trees, k-nearest neighbors, clustering algorithms, and deep learning algorithms such as convolutional neural networks (CNN), recurrent neural networks (RNN), and transformer models. The choice of algorithm depends on the nature of the data, the complexity of the problem, and the performance requirements of the application.

The performance of machine learning models is typically evaluated on a separate test set of data that was not used during training to ensure that the model can generalize to new, unseen data.

Although several specific examples of machine learning algorithms are discussed herein, the principles discussed herein can be applied to other machine learning algorithms as well. Deep learning algorithms such as convolutional neural networks, recurrent neural networks, and transformers, as well as more traditional machine learning algorithms like decision trees, random forests, and gradient boosting may be used in various machine learning applications.

Two example types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

Generating a trained machine-learning program 1800 may include multiple phases that form part of the machine-learning pipeline 1700, including for example the following phases illustrated in FIG. 17:
Data collection and preprocessing 1702: This phase may include acquiring and cleaning data to ensure that it is suitable for use in the machine learning model. This phase may also include removing duplicates, handling missing values, and converting data into a suitable format.
Feature engineering 1704: This phase may include selecting and transforming the training data 1804 to create features that are useful for predicting the target variable. Feature engineering may include (1) receiving features 1806 (e.g., as structured or labeled data in supervised learning) and/or (2) identifying features 1806 (e.g., unstructured or unlabeled data for unsupervised learning) in training data 1804 (all shown in FIG. 18).
Model selection and training 1706: This phase may include selecting an appropriate machine learning algorithm and training it on the preprocessed data. This phase may further involve splitting the data into training and testing sets, using cross-validation to evaluate the model, and tuning hyperparameters to improve performance.
Model evaluation 1708: This phase may include evaluating the performance of a trained model (e.g., the trained machine-learning program 1800) on a separate testing dataset. This phase can help determine if the model is overfitting or underfitting and determine whether the model is suitable for deployment.
Prediction 1710: This phase involves using a trained model (e.g., trained machine-learning program 1800) to generate predictions on new, unseen data.
Validation, refinement or retraining 1712: This phase may include updating a model based on feedback generated from the prediction phase, such as new data or user feedback.
Deployment 1714: This phase may include integrating the trained model (e.g., the trained machine-learning program 1800) into a more extensive system or application, such as a web service, mobile app, or IoT device. This phase can involve setting up APIs, building a user interface, and ensuring that the model is scalable and can handle large volumes of data.

FIG. 18 illustrates further details of two example phases, namely a training phase 1802 (e.g., part of the model selection and trainings 1706) and a prediction phase 1808 (part of prediction 1710). Prior to the training phase 1802, feature engineering is used to identify features 1806. This may include identifying informative, discriminating, and independent features for effectively operating the trained machine-learning program 1800 in pattern recognition, classification, and regression. In some examples, the training data 1804 includes labeled data, known for pre-identified features 1806 and one or more outcomes. Each of the features 1806 may be a variable or attribute, such as an individual measurable property of a process, article, system, or phenomenon represented by a data set (e.g., the training data 1804). Features 1806 may also be of different types, such as numeric features, strings, and graphs, and may include one or more of content 1810, concepts 1812, attributes 1814, historical data 1816, and/or user data 1818, merely for example.

In training phase 1802, the machine-learning pipeline 1828 uses the training data to find correlations among the features 1806 that affect a predicted outcome or prediction/inference data 1820.

With the training data 1804 and the identified features 1806, the trained machine-learning program 1800 is trained during the training phase 1802 during machine-learning program training 1822. The machine-learning program training 1822 appraises values of the features 1806 as they correlate to the training data 1804. The result of the training is the trained machine-learning program 1800 (e.g., a trained or learned model).

Further, the training phase 1802 may involve machine learning, in which the training data 1804 is structured (e.g., labeled during preprocessing operations). The trained machine-learning program 1800 implements a neural network 1824 capable of performing, for example, classification and clustering operations. In other examples, the training phase 1802 may involve deep learning, in which the training data 1804 is unstructured, and the trained machine-learning program 1800 implements a deep neural network 1824 that can perform both feature extraction and classification/clustering operations.

In some examples, a neural network 1824 may be generated during the training phase 1802, and implemented within the trained machine-learning program 1800. The neural network 1824 includes a hierarchical (e.g., layered) organization of neurons, with each layer consisting of multiple neurons or nodes. Neurons in the input layer receive the input data, while neurons in the output layer produce the final output of the network. Between the input and output layers, there may be one or more hidden layers, each consisting of multiple neurons.

Each neuron in the neural network 1824 operationally computes a function, such as an activation function, which takes as input the weighted sum of the outputs of the neurons in the previous layer, as well as a bias term. The output of this function is then passed as input to the neurons in the next layer. If the output of the activation function exceeds a certain threshold, an output is communicated from that neuron (e.g., transmitting neuron) to a connected neuron (e.g., receiving neuron) in successive layers. The connections between neurons have associated weights, which define the influence of the input from a transmitting neuron to a receiving neuron. During the training phase, these weights are adjusted by the learning algorithm to optimize the performance of the network. Different types of neural networks may use different activation functions and learning algorithms, affecting their performance on different tasks. The layered organization of neurons and the use of activation functions and weights enable neural networks to model complex relationships between inputs and outputs, and to generalize to new inputs that were not seen during training.

In some examples, the neural network 1824 may also be one of several different types of neural networks, such as a single-layer feed-forward network, a Multilayer Perceptron (MLP), an Artificial Neural Network (ANN), a Recurrent Neural Network (RNN), a Long Short-Term Memory Network (LSTM), a Bidirectional Neural Network, a symmetrically connected neural network, a Deep Belief Network (DBN), a Convolutional Neural Network (CNN), a Generative Adversarial Network (GAN), an Autoencoder Neural Network (AE), a Restricted Boltzmann Machine (RBM), a Hopfield Network, a Self-Organizing Map (SOM), a Radial Basis Function Network (RBFN), a Spiking Neural Network (SNN), a Liquid State Machine (LSM), an Echo State Network (ESN), a Neural Turing Machine (NTM), or a Transformer Network, merely for example.

In addition to the training phase 1802, a validation phase may be performed on a separate dataset known as the validation dataset. The validation dataset is used to tune the hyperparameters of a model, such as the learning rate and the regularization parameter. The hyperparameters are adjusted to improve the model's performance on the validation dataset.

Once a model is fully trained and validated, in a testing phase, the model may be tested on a new dataset. The testing dataset is used to evaluate the model's performance and ensure that the model has not overfitted the training data.

In prediction phase 1808, the trained machine-learning program 1800 uses the features 1806 for analyzing query data 1826 to generate inferences, outcomes, or predictions, as examples of a prediction/inference data 1820. For example, during prediction phase 1808, the trained machine-learning program 1800 generates an output. Query data 1826 is provided as an input to the trained machine-learning program 1800, and the trained machine-learning program 1800 generates the prediction/inference data 1820 as output, responsive to receipt of the query data 1826.

In some examples, the trained machine-learning program 1800 may be a generative AI model. Generative AI is a term that may refer to any type of artificial intelligence that can create new content from training data 1804. For example, generative AI can produce text, images, video, audio, code, or synthetic data similar to the original data but not identical.

Some of the techniques that may be used in generative AI are:
Convolutional Neural Networks (CNNs): CNNs may be used for image recognition and computer vision tasks. CNNs may, for example, be designed to extract features from images by using filters or kernels that scan the input image and highlight important patterns.
Recurrent Neural Networks (RNNs): RNNs may be used for processing sequential data, such as speech, text, and time series data, for example. RNNs employ feedback loops that allow them to capture temporal dependencies and remember past inputs.
Generative adversarial networks (GANs): GNNs may include two neural networks: a generator and a discriminator. The generator network attempts to create realistic content that can “fool” the discriminator network, while the discriminator network attempts to distinguish between real and fake content. The generator and discriminator networks compete with each other and improve over time.
Variational autoencoders (VAEs): VAEs may encode input data into a latent space (e.g., a compressed representation) and then decode it back into output data. The latent space can be manipulated to generate new variations of the output data. VAEs may use self-attention mechanisms to process input data, allowing them to handle long text sequences and capture complex dependencies.
Transformer models: Transformer models may use attention mechanisms to learn the relationships between different parts of input data (such as words or pixels) and generate output data based on these relationships. Transformer models can handle sequential data, such as text or speech, as well as non-sequential data, such as images or code.

In generative AI examples, the output prediction/inference data 1820 include predictions, translations, summaries or media content.

### Example Statements

In view of the above-described implementations of subject matter this application discloses the following list of examples, wherein one feature of an example in isolation or more than one feature of an example, taken in combination and, optionally, in combination with one or more features of one or more further examples are further examples also falling within the disclosure of this application.

Example 1 is a system comprising: at least one processor; and a memory storing instructions that, when executed by the at least one processor, cause the system to perform operations comprising: obtaining an input in a first modality; and processing the input by a trained multi-modal diffusion model, the multi-modal diffusion model comprising: a first modality path comprising a plurality of diffusion transformer (DiT) blocks of a DiT model pretrained to generate outputs of the first modality; a second modality path comprising a plurality of DiT blocks of a DiT model pretrained to generate outputs of a second modality; a fusion block trained to: receive first modality activations from a first DiT block of the first modality path based on the input; receive second modality activations from a first DiT block of the second modality path; establish temporal correspondence between the first modality activations and second modality activations to generate modified first modality activations and modified second modality activations; provide the modified first modality activations to a second DiT block of the first modality path; and provide the modified second modality activations to a second DiT block of the second modality path; and an output block to provide an output in the second modality, the output being based on first modality activations from the second DiT block of the first modality path, the output being at least partially temporally aligned with the input.

In Example 2, the subject matter of Example 1 includes, wherein: the operations further comprise combining the input with noise to generate a noised input; and the first DiT block of the first plurality of DiT blocks generates the first modality activations based on the noised input.

In Example 3, the subject matter of Example 2 includes, wherein: the combining of the input with the noise to generate the noised input comprises selecting a noise level to preserve details in the input that are relevant for cross-modal alignment.

In Example 4, the subject matter of Examples 2-3 includes, wherein: the processing of the input by the multi-modal diffusion model comprises repeatedly iterating a diffusion process to progressively remove noise from the noised input.

In Example 5, the subject matter of Example 4 includes, wherein: the first modality is video and the second modality is audio.

In Example 6, the subject matter of Example 5 includes, wherein: the combining of the input with the noise to generate the noised input comprises applying a noise level between 0.94 and 0.98, wherein a noise level of 1.0 corresponds to a clean sample with zero noise.

In Example 7, the subject matter of Examples 4-6 includes, wherein: the first modality is audio and the second modality is video.

In Example 8, the subject matter of Example 7 includes, wherein: the combining of the input with the noise to generate the noised input comprises applying a noise level between 0.75 and 0.85, wherein a noise level of 1.0 corresponds to a clean sample with zero noise.

In Example 9, the subject matter of Examples 1-8 includes, wherein: the multi-modal diffusion model receives a further input in a third modality and conditions the output on the further input.

In Example 10, the subject matter of Examples 1-9 includes, wherein: the multi-modal diffusion model further comprises one or more additional fusion blocks, each trained to: receive first modality activations from a respective additional DiT block of the first modality path; receive second modality activations from a respective additional DiT block of the second modality path; establish temporal correspondence between the first modality activations and second modality activations to generate modified first modality activations and modified second modality activations; provide the modified first modality activations to a respective further additional DiT block of the first modality path; and provide the modified second modality activations to a respective further additional DiT block of the second modality path.

In Example 11, the subject matter of Example 10 includes, wherein: the fusion block and the one or more additional fusion blocks are interleaved with the DiT blocks of the first modality path and the second modality path at regular intervals.

In Example 12, the subject matter of Examples 1-11 includes, wherein: the fusion block comprises a self-attention mechanism to establish the temporal correspondence between the first modality activations and second modality activations.

In Example 13, the subject matter of Example 12 includes, wherein: the self-attention mechanism comprises rotary position embeddings (RoPE) that bias tokens of the first modality activations and the second modality activations corresponding to a same temporal position to preferentially exchange information to generate the modified first modality activations and the modified second modality activations.

In Example 14, the subject matter of Examples 1-13 includes, wherein the operations further comprise: obtaining a training dataset comprising first modality training data samples and corresponding second modality training data samples temporally aligned to the first modality training data samples; and training the multi-modal diffusion model to generate outputs of the second modality based on inputs of the first modality by: performing supervised learning using the training dataset; maintaining constant values of pretrained parameters of the DiT blocks of the first modality path and second modality path during supervised learning; and adjusting learnable parameters of the fusion blocks during supervised learning.

In Example 15, the subject matter of Example 14 includes, wherein the operations further comprise: applying a constant noise level to the first modality training data samples used to train the multi-modal diffusion model; and applying a variable respective noise level to each respective second modality training data sample used to train the multi-modal diffusion model, the constant noise level being lower than a mean of the variable respective noise levels.

Example 16 is a method comprising: obtaining an input in a first modality; and processing the input by a trained multi-modal diffusion model, the multi-modal diffusion model comprising: a first modality path comprising a plurality of diffusion transformer (DiT) blocks of a DiT model pretrained to generate outputs of the first modality; a second modality path comprising a plurality of DiT blocks of a DiT model pretrained to generate outputs of a second modality; a fusion block trained to: receive first modality activations from a first DiT block of the first modality path based on the input; receive second modality activations from a first DiT block of the second modality path; establish temporal correspondence between the first modality activations and second modality activations to generate modified first modality activations and modified second modality activations; provide the modified first modality activations to a second DiT block of the first modality path; and provide the modified second modality activations to a second DiT block of the second modality path; and an output block to provide an output in the second modality, the output being based on first modality activations from the second DiT block of the first modality path, the output being at least partially temporally aligned with the input.

In Example 17, the subject matter of Example 16 includes, wherein: the fusion block comprises a self-attention mechanism to establish the temporal correspondence between the first modality activations and second modality activations.

In Example 18, the subject matter of Example 17 includes, wherein: the self-attention mechanism comprises rotary position embeddings (RoPE) that bias tokens of the first modality activations and the second modality activations corresponding to a same temporal position to preferentially exchange information to generate the modified first modality activations and the modified second modality activations.

In Example 19, the subject matter of Examples 16-18 includes, obtaining a training dataset comprising first modality training data samples and corresponding second modality training data samples temporally aligned to the first modality training data samples; applying a constant noise level to the first modality training data samples; applying a variable respective noise level to each respective second modality training data sample, the constant noise level being lower than a mean of the variable respective noise levels; and training the multi-modal diffusion model to generate outputs of the second modality based on inputs of the first modality by: performing supervised learning using the training dataset; maintaining constant values of pretrained parameters of the DiT blocks of the first modality path and second modality path during supervised learning; and adjusting learnable parameters of the fusion blocks during supervised learning.

Example 20 is a non-transitory computer-readable storage medium, the computer-readable storage medium including instructions that, when executed by at least one processor of a system, cause the system to perform operations comprising: obtaining an input in a first modality; and processing the input by a trained multi-modal diffusion model, the multi-modal diffusion model comprising: a first modality path comprising a plurality of diffusion transformer (DiT) blocks of a DiT model pretrained to generate outputs of the first modality; a second modality path comprising a plurality of DiT blocks of a DiT model pretrained to generate outputs of a second modality; a fusion block trained to: receive first modality activations from a first DiT block of the first modality path based on the input; receive second modality activations from a first DiT block of the second modality path; establish temporal correspondence between the first modality activations and second modality activations to generate modified first modality activations and modified second modality activations; provide the modified first modality activations to a second DiT block of the first modality path; and provide the modified second modality activations to a second DiT block of the second modality path; and an output block to provide an output in the second modality, the output being based on first modality activations from the second DiT block of the first modality path, the output being at least partially temporally aligned with the input.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

Other technical features may be readily apparent to one skilled in the art from the figures, descriptions, and claims herein.

### Term Examples

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component”(or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure. “Extended reality” (XR) refers, for example, to an interactive experience of a real-world

environment where physical objects that reside in the real-world are “augmented” or enhanced by computer-generated digital content (also referred to as virtual content or synthetic content). XR can also refer to a system that enables a combination of real and virtual worlds, real-time interaction, and 3D registration of virtual and real objects. A user of an XR system perceives virtual content that appears to be attached to, or interacts with, a real-world physical object. XR includes augmented reality (AR) and virtual reality (VR).

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Network” may include, for example, one or more portions of a network that may be an ad hoc network, an intranet, an extranet, a Virtual Private Network (VPN), a Local Area Network (LAN), a Wireless LAN (WLAN), a Wide Area Network (WAN), a Wireless WAN (WWAN), a Metropolitan Area Network (MAN), the Internet, a portion of the Internet, a portion of the Public Switched Telephone Network (PSTN), a Voice over IP (VoIP) network, a cellular telephone network, a 5G™ network, a wireless network, a Wi-Fi® network, a Wi-Fi 6® network, a Li-Fi network, a Zigbee® network, a Bluetooth® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as third Generation Partnership Project (3GPP) including 4G, fifth-generation wireless (5G) networks, Universal Mobile Telecommunications System (UMTS), High Speed Packet Access (HSPA), Long Term Evolution (LTE) standard, others defined by various standard-setting organizations, other long-range protocols, or other data transfer technology.

“Non-transitory computer-readable storage medium” refers, for example, to a tangible medium that is capable of storing, encoding, or carrying the instructions for execution by a machine.

“Processor” refers to any circuit or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” refers, for example, to a device accessed, controlled or owned by a user and with which the user interacts perform an action, or an interaction with other users or computer systems.

As used in this disclosure, phrases of the form “at least one of an A, a B, or a C,” “at least one of A, B, or C,” “at least one of A, B, and C,” and the like, should be interpreted to select at least one from the group that comprises “A, B, and C.” Unless explicitly stated otherwise in connection with a particular instance in this disclosure, this manner of phrasing does not mean “at least one of A, at least one of B, and at least one of C.” As used in this disclosure, the example “at least one of an A, a B, or a C,” would cover any of the following selections: {A}, {B}, {C}, {A, B}, {A, C}, {B, C}, and {A, B, C}.

Unless the context clearly requires otherwise, throughout the description and the claims, the words “comprise,” “comprising,” and the like are to be construed in an inclusive sense, as opposed to an exclusive or exhaustive sense, e.g., in the sense of “including, but not limited to.”

As used herein, the terms “connected,” “coupled,” or any variant thereof means any connection or coupling, either direct or indirect, between two or more elements; the coupling or connection between the elements can be physical, logical, or a combination thereof.

Additionally, the words “herein,” “above,” “below,” and words of similar import, when used in this application, refer to this application as a whole and not to any portions of this application. Where the context permits, words using the singular or plural number may also include the plural or singular number respectively.

The word “or” in reference to a list of two or more items, covers all the following interpretations of the word: any one of the items in the list, all the items in the list, and any combination of the items in the list. Likewise, the term “and/or” in reference to a list of two or more items, covers all the following interpretations of the word: any one of the items in the list, all the items in the list, and any combination of the items in the list.

The various features, operations, or processes described herein may be used independently of one another, or may be combined in various ways. All possible combinations and sub-combinations are intended to fall within the scope of this disclosure. In addition, certain method or process blocks may be omitted in some implementations.

Although some examples, e.g., those depicted in the drawings, include a particular sequence of operations, the sequence may be altered without departing from the scope of the present disclosure. For example, some of the operations depicted may be performed in parallel or in a different sequence that does not materially affect the functions as described in the examples. In other examples, different components of an example device or system that implements an example method may perform functions at substantially the same time or in a specific sequence.

### Conclusion

Described examples of temporally-aligned cross-modal audiovisual diffusion models seek to provide technical solutions to one or more example technical problems, such as the following.

First, existing approaches to cross-modal generation between audio and video modalities struggle with achieving precise temporal alignment. Some existing approaches rely on specialized feature extractors pretrained for other tasks, such as CLIP, ImageBind, or CAVP, to condition generation of one modality from another. While these approaches can achieve semantic alignment, they often fail to maintain temporal coherence between the generated content and the conditioning input. For example, when generating audio from video, sounds like explosions or drumming may not be synchronized with the corresponding visual events. The described examples may address this problem by leveraging the activations of pretrained diffusion models as conditioning signals, bypassing the need for separate feature extractors. The fusion blocks with rotary position embeddings (RoPE) establish temporal correspondence between tokens from both modalities that correspond to the same temporal position, biasing them to preferentially exchange information. This temporal alignment mechanism helps ensure that events in the generated output align with corresponding events in the input, resulting in significantly improved temporal alignment as measured by Onset Accuracy metrics.

Second, existing approaches typically require separate architectures and training methodologies for video-to-audio (V2A) and audio-to-video (A2V) generation tasks, leading to increased complexity and resource requirements. The described examples address this problem by providing a unified framework for both V2A and A2V generation within the same architecture. The system uses a symmetrical design with two modality paths connected through fusion blocks that enable bidirectional information exchange. This unified approach allows for a more efficient implementation where the same architectural principles can be applied for both generation directions. The fusion blocks establish temporal correspondence between activations from both modality paths, ensuring that the generated output in either direction is temporally aligned with the input. While optimal performance is achieved with separate parameter sets for V2A and A2V tasks, the architecture itself remains consistent, simplifying deployment for applications requiring comprehensive functionality.

Third, existing approaches to cross-modal conditioning often fail to leverage the full potential of pretrained generative models. The described examples address this problem through a symmetric feature reinjection mechanism that continuously refines the conditioning features according to the generated modality. After each fusion block processes the activations from both modalities, the modified activations are provided back to subsequent DiT blocks in both paths. This approach allows for continuous refinement of the conditioning features, improving the quality of cross-modal alignment throughout the diffusion process. Experimental ablation studies have shown that this symmetric feature reinjection significantly outperforms approaches that do not reinject the modified features back into the conditioning modality path.

Fourth, existing methods struggle with determining the optimal noise level for conditioning features in diffusion-based cross-modal generation. The described technology addresses this problem by applying different noise levels to the conditioning modality and the modality being generated. For the conditioning modality, a small amount of noise (e.g., 0.96 for video inputs in V2A or 0.8 for audio inputs in A2V, as described above) is applied to preserve details relevant for cross-modal alignment, while a higher level of noise (e.g., 0.0) is applied to the modality being generated. This asymmetric noise application enables the model to learn how to leverage the conditioning modality effectively.

Fifth, existing approaches to integrating multiple modality paths often lack effective mechanisms for information exchange. The described technology solves this problem through fusion blocks that are interleaved at regular intervals throughout the DiT blocks of both modality paths. These fusion blocks receive activations from both modality paths, establish temporal correspondence between them, and provide modified activations back to both paths. Ablation studies have shown that uniformly distributing the fusion blocks throughout the architecture provides superior performance compared to alternative arrangements such as placing all fusion blocks at the beginning, middle, or end of the model. This interleaved arrangement allows for iterative refinement of the conditioning features throughout the diffusion process, improving the quality of cross-modal alignment.

Other technical problems may be addressed by various examples described herein, as will be appreciated by a skilled person.

What is claimed is:

1. A system comprising:
at least one processor; and
a memory storing instructions that, when executed by the at least one processor, cause the system to perform operations comprising:
obtaining an input in a first modality; and
processing the input by a trained multi-modal diffusion model, the multi-modal diffusion model comprising:
a first modality path comprising a plurality of diffusion transformer (DiT) blocks of a DiT model pretrained to generate outputs of the first modality;
a second modality path comprising a plurality of DiT blocks of a DiT model pretrained to generate outputs of a second modality;
a fusion block trained to:
receive first modality activations from a first DiT block of the first modality path based on the input;
receive second modality activations from a first DiT block of the second modality path;
establish temporal correspondence between the first modality activations and second modality activations to generate modified first modality activations and modified second modality activations;
provide the modified first modality activations to a second DiT block of the first modality path; and
provide the modified second modality activations to a second DiT block of the second modality path; and
an output block to provide an output in the second modality, the output being based on first modality activations from the second DiT block of the first modality path, the output being at least partially temporally aligned with the input.

2. The system of claim 1, wherein:
the operations further comprise combining the input with noise to generate a noised input; and
the first DiT block of the first plurality of DiT blocks generates the first modality activations based on the noised input.

3. The system of claim 2, wherein:
the combining of the input with the noise to generate the noised input comprises selecting a noise level to preserve details in the input that are relevant for cross-modal alignment.

4. The system of claim 2, wherein:
the processing of the input by the multi-modal diffusion model comprises repeatedly iterating a diffusion process to progressively remove noise from the noised input.

5. The system of claim 4, wherein:
the first modality is video and the second modality is audio.

6. The system of claim 5, wherein:
the combining of the input with the noise to generate the noised input comprises applying a noise level between 0.94 and 0.98, wherein a noise level of 1.0 corresponds to a clean sample with zero noise.

7. The system of claim 4, wherein:
the first modality is audio and the second modality is video.

8. The system of claim 7, wherein:
the combining of the input with the noise to generate the noised input comprises applying a noise level between 0.75 and 0.85, wherein a noise level of 1.0 corresponds to a clean sample with zero noise.

9. The system of claim 1, wherein:
the multi-modal diffusion model receives a further input in a third modality and conditions the output on the further input.

10. The system of claim 1, wherein:
the multi-modal diffusion model further comprises one or more additional fusion blocks, each trained to:
receive first modality activations from a respective additional DiT block of the first modality path;
receive second modality activations from a respective additional DiT block of the second modality path;
establish temporal correspondence between the first modality activations and second modality activations to generate modified first modality activations and modified second modality activations;
provide the modified first modality activations to a respective further additional DiT block of the first modality path; and
provide the modified second modality activations to a respective further additional DiT block of the second modality path.

11. The system of claim 10, wherein:
the fusion block and the one or more additional fusion blocks are interleaved with the DiT blocks of the first modality path and the second modality path at regular intervals.

12. The system of claim 1, wherein:
the fusion block comprises a self-attention mechanism to establish the temporal correspondence between the first modality activations and second modality activations.

13. The system of claim 12, wherein:
the self-attention mechanism comprises rotary position embeddings (RoPE) that bias tokens of the first modality activations and the second modality activations corresponding to a same temporal position to preferentially exchange information to generate the modified first modality activations and the modified second modality activations.

14. The system of claim 1, wherein the operations further comprise:
obtaining a training dataset comprising first modality training data samples and corresponding second modality training data samples temporally aligned to the first modality training data samples; and
training the multi-modal diffusion model to generate outputs of the second modality based on inputs of the first modality by:
performing supervised learning using the training dataset;
maintaining constant values of pretrained parameters of the DiT blocks of the first modality path and second modality path during supervised learning; and
adjusting learnable parameters of the fusion blocks during supervised learning.

15. The system of claim 14, wherein the operations further comprise:
applying a constant noise level to the first modality training data samples used to train the multi-modal diffusion model; and
applying a variable respective noise level to each respective second modality training data sample used to train the multi-modal diffusion model,
the constant noise level being lower than a mean of the variable respective noise levels.

16. A method comprising:
obtaining an input in a first modality; and
processing the input by a trained multi-modal diffusion model, the multi-modal diffusion model comprising:
a first modality path comprising a plurality of diffusion transformer (DiT) blocks of a DiT model pretrained to generate outputs of the first modality;
a second modality path comprising a plurality of DiT blocks of a DiT model pretrained to generate outputs of a second modality;
a fusion block trained to:
receive first modality activations from a first DiT block of the first modality path based on the input;
receive second modality activations from a first DiT block of the second modality path;
establish temporal correspondence between the first modality activations and second modality activations to generate modified first modality activations and modified second modality activations;
provide the modified first modality activations to a second DiT block of the first modality path; and
provide the modified second modality activations to a second DiT block of the second modality path; and
an output block to provide an output in the second modality, the output being based on first modality activations from the second DiT block of the first modality path, the output being at least partially temporally aligned with the input.

17. The method of claim 16, wherein:
the fusion block comprises a self-attention mechanism to establish the temporal correspondence between the first modality activations and second modality activations.

18. The method of claim 17, wherein:
the self-attention mechanism comprises rotary position embeddings (RoPE) that bias tokens of the first modality activations and the second modality activations corresponding to a same temporal position to preferentially exchange information to generate the modified first modality activations and the modified second modality activations.

19. The method of claim 16, further comprising:
obtaining a training dataset comprising first modality training data samples and corresponding second modality training data samples temporally aligned to the first modality training data samples;
applying a constant noise level to the first modality training data samples;
applying a variable respective noise level to each respective second modality training data sample, the constant noise level being lower than a mean of the variable respective noise levels; and
training the multi-modal diffusion model to generate outputs of the second modality based on inputs of the first modality by:
performing supervised learning using the training dataset;
maintaining constant values of pretrained parameters of the DiT blocks of the first modality path and second modality path during supervised learning; and
adjusting learnable parameters of the fusion blocks during supervised learning.

20. A non-transitory computer-readable storage medium, the computer-readable storage medium including instructions that, when executed by at least one processor of a system, cause the system to perform operations comprising:
obtaining an input in a first modality; and
processing the input by a trained multi-modal diffusion model, the multi-modal diffusion model comprising:
a first modality path comprising a plurality of diffusion transformer (DiT) blocks of a DiT model pretrained to generate outputs of the first modality;
a second modality path comprising a plurality of DiT blocks of a DiT model pretrained to generate outputs of a second modality;
a fusion block trained to:
receive first modality activations from a first DiT block of the first modality path based on the input;
receive second modality activations from a first DiT block of the second modality path;
establish temporal correspondence between the first modality activations and second modality activations to generate modified first modality activations and modified second modality activations;
provide the modified first modality activations to a second DiT block of the first modality path; and
provide the modified second modality activations to a second DiT block of the second modality path; and
an output block to provide an output in the second modality, the output being based on first modality activations from the second DiT block of the first modality path, the output being at least partially temporally aligned with the input.
